(19) United States
(12) Patent Application Publication
(10) Pub. No.: US 2014/0190023 A1
(43) Pub. Date: Jul. 10, 2014

(54) Dual Reciprocating Apparatus and Saw Blades for Use Therewith

(71) Applicants: Marc Vitantonio, South Russell, OH (US); Trevor Jackson, Kirtland, OH (US); Doug Gall, Strongsville, OH (US); Donald C. Fuchs, JR., Mentor, OH (US); Robert Soreo, Cleveland Heights, OH (US)

(72) Inventors: Marc Vitantonio, South Russell, OH (US); Trevor Jackson, Kirtland, OH (US); Doug Gall, Strongsville, OH (US); Donald C. Fuchs, JR., Mentor, OH (US); Robert Soreo, Cleveland Heights, OH (US)

(73) Assignee: Infusion Brands International, Inc., Clearwater, FL (US)

(21) Appl. No.: 14/241,476

(22) PCT Filed: Aug. 31, 2012
(86) PCT No.: PCT/US2012/053351

§ 371 Date: Feb. 27, 2014

Related U.S. Application Data
(63) Continuation-in-part of application No. 13/394,671, filed on Oct. 31, 2013.
(60) Provisional application No. 61/529,372, filed on Aug. 31, 2011.
(60) Provisional application No. 61/547,092, filed on Oct. 14, 2011.
(60) Provisional application No. 61/560,457, filed on Nov. 16, 2011.

(51) Int. Cl. B23D 51/16; B23D 61/12

(52) U.S. Cl. CPC B23D 51/16; B23D 61/121
USPC 30/369; 83/838

(57) ABSTRACT

A reciprocating saw and one or more blades for cutting material. The reciprocating saw includes a drive system and a gear arrangement that is designed to cause first and second reciprocating saw blades to partially or fully reciprocate in opposite directions. The two reciprocating saw blades can include a tooth configuration that facilitates in maintaining the blades together during the cutting of material.

The present invention claims priority on U.S. Provisional Patent Application Ser. Nos. 61/529,372 filed Aug. 31, 2011; 61/547,092 filed Oct. 14, 2011; and 61/560,457 filed Nov. 16, 2011, all of which are incorporated herein by reference. The present invention also claims priority on U.S. patent application Ser. No. 13/394,671 filed Mar. 7, 2012, which in turn claims priority on PCT Application Serial No. PCT/US2012/027380 filed Mar. 3, 2012, which are both incorporated herein by reference.

The present invention is related to cutting devices, particularly directed to power saws, more particularly directed to a power saw that includes a plurality of saw blades that can be moved independently of one another, still more particularly to a power saw that includes two saw blades that can be simultaneously moved in opposite directions to one another during the cutting of material, and yet still more particularly to blades that can be used with the power saw.

### BACKGROUND OF THE INVENTION

Reciprocating saws are known in the art and are used to cut many types of materials. The serrated blade cuts materials as the blade reciprocates back and forth. Most reciprocating tools are driven by an electric motor such as reciprocating saws. A rotating shaft or cam is generally used to cause the saw blade to reciprocate. Generally, the reciprocating saw is driven by an electric motor that has a rotating output shaft. The rotating motion generated by the motor is then translated into reciprocating motion to move the saw blade.

Several non-limiting prior art reciprocating power saws are illustrated in U.S. Pat. Nos. D642,028; 7,963,043; D631,314; 8,006,392; 7,797,841; 7,721,450; D612,700; 7,665,216; D608,611; 7,600,458; D596,005; D591,574; 7,493,698; 7,448,137; 7,437,824; 7,426,786; D572,563; 7,395,603; D560,988; D558,550; D558,018; D551,930; D544,327; 7,225,714; 7,225,546; 7,204,026; D538,617; 7,188,425; 7,168,169; 7,127,973; D530,174; 7,114,259; D527,967; D527,597; D527,596; D527,233; 7,096,590; 7,096,589; D525,845; D525,842; 7,082,689; D524,623; D524,131; D524,130; D523,719; D523,310; 7,032,486; 6,912,790; D506,117; D504,603; 6,871,405; 6,851,194; 6,851,193; D500,651; 6,829,831; 6,810,589; 6,782,781; 6,772,662; 6,758,119; 6,742,267; 6,705,017; D487,384; D485,479; D485,142; D485,141; D485,140; D484,759; 6,671,969; 6,651,348; D480,616; D479,453; D479,447; D479,107; D479,106; D475,907; 6,568,089; D474,088; D471,782; D471,418; D471,417; D468,982; 6,508,151; 6,477,884; D465,138; 6,467,177; 6,449,851; 6,401,585; D456,233; D448,634; D447,924; 6,286,217; 6,272,757; 6,264,211; 6,249,979; 6,237,179; 6,234,255; 6,233,833; 6,212,781; D434,627; 6,112,420; D427,865; 6,065,216; 6,007,541; 5,940,977; 5,918,525; D408,699; 5,860,218; 5,855,070; D401,128; 5,782,000; 5,724,742; 5,724,741; 5,722,309; D379,291; 5,598,636; D376,525; 5,421,232; 5,421,091; D358,315; 5,392,519; 5,349,754; 5,271,154; 5,193,281; 5,155,914; D322,921; 5,031,324; 4,969,270; 4,962,588; D310,008; 4,934,056; D308,469; 4,798,001; 4,550,501; 4,145,811; 4,038,721; and 3,945,120; and United States Patent Publication Nos. 2011/0131819; 2011/0107608; 2011/0061245; 2010/0218655; 2010/0218389; 2010/0180455; 2010/0154231; 2010/0031517; 2009/0241354; 2009/0223071; 2009/0151174; 2009/0113727; 2009/0106986; 2009/0049973; 2008/0307936; 2008/0276470; 2008/0235961; 2008/0172890; 2008/0141545; 2008/0104853; 2008/0047150; 2008/0041174; 2008/0010840; 2007/0214660; 2007/0209217; 2007/0209162; 2007/0163415; 2007/0151112; 2007/0131076; 2007/0101587; 2007/0068012; 2007/0000137; 2006/0288591; 2006/0260141; 2006/0137498; 2006/0130628; 2006/0101650; 2006/0096104; 2006/0060054; 2005/0262710; 2005/0235799; 2005/0223569; 2005/0211046; 2005/0211023; 2005/0199117; 2005/0183271; 2005/0178012; 2005/0144791; 2005/0132583; 2005/0120568; 2005/0103320; 2005/0102846; 2005/0092156; 2005/0005458; 2004/0255474; 2004/0237678; 2004/0231170; 2004/0221461; 2004/0181952; 2004/0143976; 2004/0117993; 2004/0049928; 2004/0003504; 2003/0150120; 2003/0145472; 2003/0140507; 2003/0121389; 2003/0110646; 2003/0110645; 2003/0101600; 2003/0051352; 2003/0014869; 2003/0009888; 2002/0170335; 2002/0095798; 2002/0026718; 2001/0034942; and 2001/0034941, all of which are incorporated herein by reference.

Although this type of cutting device is effective for many applications, there are several disadvantages to the use of such a device. One disadvantage is that the reciprocation of the cutting blade can cause the material being cut to move back and forth due to the friction and cutting action of the cutting blade when the cutting blade moves back and forth during the cutting of the material.

Such movement of the material during the cutting process can result in improper cutting of the material and damage to the material. Also, when the material to be cut is held in place, the reciprocating saw will tend to move back and forth during cutting thus making it difficult to hold the saw in the proper position and increasing the rate of fatigue on the user to properly hold and position the saw during cutting of a material. Also, some cutting operations perform better with different stroke lengths; however, most reciprocating saws operate with only a single stroke length.

In view of the current state of the art regarding reciprocating saws, there is a need for an improved reciprocating saw and saw blade that reduces the forward/backward force, vibration and jerking actions caused by the reciprocating saw blade during the cutting operation, reduces fatigue to the user when using the reciprocating saw, improves accuracy of the cutting operation through material, provides for a smoother cut through the material, and inhibits or prevents blade separation during the operation of the reciprocating saw.

### SUMMARY OF THE INVENTION

The present invention is directed to a multi-blade reciprocating saw and blades for use with such saw that addresses the past deficiencies of prior art reciprocating saws. Generally, the multi-blade reciprocating saw includes two reciprocating blades. The size, shape, length, thickness and/or material of the reciprocating saw and saw blades used with the reciprocating saw are non-limiting.

The reciprocating saw blades used on the reciprocating saw generally have the same size, shape, length, thickness; however, this is not required. The present invention is directed to reciprocating saws, more particularly directed to a reciprocating saw that includes a plurality of reciprocating saw blades that can be moved independently of one another, and still more particularly to a reciprocating saw that includes two reciprocating saw blades that can be simultaneously moved in opposite directions to one another during the cutting of material. The present invention pertains to the concept of including two reciprocating saw blades that can be reciprocated together in opposite directions from one another during the cutting of material. The present invention contemplates a power tool that is dedicated for use with one or more reciprocating saw blades. The ability to reciprocate two reciprocating saw blades in opposite directions from one another during the cutting of material can result in 1) improved cutting of material by the reciprocating saw blades, 2) reduce the vibration caused by the cutting of material by the reciprocating saw blades and/or operation of the reciprocating saw and thereby reduce fatigue to the user when using the reciprocating saw and/or facilitate in the ease, quality and/or accuracy of a cut in a material during the use of the reciprocating saw, 3) improvements in the speed and/or accuracy of the cutting operation through a material, 4) a reduction of the backward/forward forces on the user when using the reciprocating saw to cut through material and thereby reduce fatigue to the user when using the reciprocating saw and/or facilitate in the ease, quality and/or accuracy of a cut in a material during the use of the reciprocating saw, 5) a reduction of the jerking actions caused by the reciprocating saw blade during the cutting operation and thereby reduce fatigue to the user when using the reciprocating saw and/or facilitate in the ease, quality and/or accuracy of a cut in a material during the use of the reciprocating saw, 6) improvements in the accuracy of the cutting operation through material, and/or 7) providing for smoother cuts and/or less abrupt cut through the material.

In one non-limiting aspect of the present invention, the reciprocating saw blades are caused to reciprocate in opposite directions to one another during the cutting of a material. The speed or rate of reciprocation of the two reciprocating saw blades, when reciprocating in opposite directions, can be the same or different. In one non-limiting aspect of the invention, the speed or rate of reciprocation of the two reciprocating saw blades when reciprocating in opposite directions can be the same.

In another and/or alternative non-limiting aspect of the present invention, the two reciprocating saw blades can have the same or different length, tooth location and/or shape. In one non-limiting embodiment of the invention, the length of the two reciprocating saw blades is the same; however, this is not required. In another and/or alternative non-limiting embodiment of the invention, the tooth location of the two reciprocating saw blades is the same; however, this is not required. Generally, the tooth location is on the bottom edge of the reciprocating saw blade; however, it can be appreciated that teeth can be positioned on both the top and bottom edge of the reciprocating saw blade; however, this is not required. In still another and/or alternative non-limiting embodiment of the invention, the shape of the two reciprocating saw blades is the same; however, this is not required. When the length, tooth location and shape of the two reciprocating saw blades are the same, the two reciprocating saw blades can be interchangeable with one another without affecting the operation of the reciprocating saw; however, this is not required. In yet another and/or alternative non-limiting embodiment of the invention, the connection arrangement of the two reciprocating saw blades can be the same or different. When the reciprocating saw blades have the same connection arrangement, either reciprocating saw blade can be connected to the first or second blade carrying arm without affecting the operation of the reciprocating saw; however, this is not required. When the reciprocating saw blades have a different connection arrangement, one reciprocating saw blade can be designed to connect only to one of the blade carrying arms and the other reciprocating saw blade can be designed to connect only to the other blade carrying arm; however, this is not required. The two reciprocating saw blades can include a tooth configuration the inhibits or prevents separation of the blades during the operation of the reciprocating saw.

In still another and/or alternative non-limiting aspect of the present invention, the reciprocating saw can optionally include a quick connect/release arrangement for one or both reciprocating saw blades; however, this is not required. The configuration of the quick connect/release arrangement, when included on the reciprocating saw, is non-limiting. In one non-limiting configuration, this is provided on one or more depressible buttons on the reciprocating saw to enable one or both reciprocating saw blades to be connected to and/or released from the blade carrying arms on the reciprocating saw. The location of the one or more buttons on the reciprocating saw is non-limiting. As can be appreciated, one or more of the reciprocating saw blades can be connected to the blade-carrying arms on the reciprocating saw by use of a screw, a hex bolt, etc. instead of a blade carrying arm on the reciprocating saw.

In yet another and/or alternative non-limiting aspect of the present invention, the configuration of the cutting teeth on the first and second reciprocating saw blades can be the same or different. In one non-limiting embodiment of the invention, the teeth configuration on each of the reciprocating saw blades is the same. In another non-limiting embodiment of the invention, the teeth configuration on each of the reciprocating saw blades is different. In still another non-limiting embodiment of the invention, the teeth configuration on one or both of the reciprocating saw blades enables the reciprocating saw blades to cut material when moving in both a forward and backward direction; however, this is not required. In yet another non-limiting embodiment of the invention, the one or more teeth on one or both of the reciprocating saw blades angle outwardly from the central cutting axis of the reciprocating saw blades. Such a reciprocating saw blade configuration can be used to 1) cause one or both reciprocating saw blades to move toward one another during the cutting of material, 2) facilitate in the movement of cut material away from one or both reciprocating saw blades, and/or 3) increase the ease of cutting through a material; however, this is not required.

The depth between the teeth can be the same or different along the longitudinal length of the reciprocating saw blade and can be the same or different. The height of the teeth along the longitudinal length of the reciprocating saw blade can be the same or different. The configuration of the teeth of the inner and/or outer reciprocating saw blades is non-limiting.

In still yet another and/or alternative non-limiting aspect of the present invention, the reciprocating saw is a dedicated tool for use with one or more reciprocating saw blades. The reciprocating saw can be battery powered and/or powered by an AC current power cord. In one non-limiting embodiment, when two reciprocating saw blades are connected to the reciprocating saw, the reciprocating saw includes gearing that enables the two reciprocating saw blades to reciprocate in opposite directions; however, this is not required. The reciprocating saw can include gearing that enables the two reciprocating saw blades to be reciprocated in opposite directions at the same or different speeds. In another and/or alternative non-limiting embodiment of the invention, the reciprocating saw can include one or more optional features such as, but not limited to, a “continuous on” button, a button to activate a light or laser, a level indicator, a speed controller, a “lock off” button, battery powered motor, rechargeable battery, removable battery, vibration reducing hand grip, reducing vibration nose grip, reduced slip hand grip, tiltable handle, rotatable handle, etc.; however, this is not required.

In another and/or alternative non-limiting aspect of the present invention, the reciprocating saw can optionally include a laser or light switch to activate and/or deactivate one or more lights or lasers on the reciprocating saw. The location of the switch and one or more lasers and/or lights on the reciprocating saw is non-limiting. When one or more lasers and/or lights are included on the reciprocating saw, at least one laser and/or light is generally located at the front or front portion of the reciprocating saw to 1) illuminate a region about the reciprocating saw blades to facilitate in the illumination of the region to be cut by the reciprocating saw blades, and/or 2) create a guide line or cut line to facilitate in guiding the one or more reciprocating saw blades along the material to be cut; however, this is not required. In one non-limiting arrangement, the laser or light switch is located on a region of the reciprocating saw that is grasped by the user (e.g., handle, etc.) when using the reciprocating saw; however, this is not required. The laser or light switch can be designed to be a depressible or contact switch that automatically causes one or more laser and/or lights to illuminate when the reciprocating saw is grasped by the user during use of the reciprocating saw; however, this is not required. In such an arrangement, the switch can be located on top of or hidden beneath an outer surface (e.g., soft outer surface grip, etc.) of the reciprocating saw.

In still another and/or alternative non-limiting aspect of the present invention, the two reciprocating saw blades can optionally include a connector arrangement that connects the two reciprocating saw blades together and enables the two reciprocating saw blades to reciprocate in opposite directions. The configuration of the connection arrangement is non-limiting. In one non-limiting arrangement, the connection arrangement includes a pin and slot arrangement wherein one of the reciprocating saw blades includes a slot and the other reciprocating saw blade includes a pin that is designed to be moveable in the slot of the other reciprocating saw blade. The pin may have a larger head (e.g., cone shaped head, etc.) to retain the pin to the slot in the reciprocating blade during the operation of the two reciprocating saw blades; however, this is not required. The connection arrangement, when used, can be designed to facilitate in maintaining the spacing of the two reciprocating saw blades from each other during the operation of the reciprocating saw and/or the cutting of material by the two reciprocating saw blades.

In yet another and/or alternative non-limiting aspect of the present invention, the reciprocating saw optionally includes a gearing arrangement that enables the user to select a plurality of stroke options for the one or more reciprocating saw blades. As defined herein, “stroke” is the difference between the maximum forward and rearward or backward position of the reciprocating saw blade during the operation of the reciprocating saw. The gearing arrangement can be designed to enable two or more different stroke values to be used when cutting the material. In one non-limiting arrangement, the one or more reciprocating saw blades can have a different stroke value by merely selecting the rotation direction of the motor of the reciprocating saw. For example, when the motor is selected to operate in the clockwise direction, the stroke value of the one or more reciprocating saw blades can be a stoke value A (e.g., 0.75 inches, 1 inch, etc.), and when the motor is selected to operate in the counterclockwise direction, the stroke value of the one or more reciprocating saw blades can be a stroke value B (e.g., 0.5 inches, 0.25 inches, etc.). As can be appreciated, the gear arrangement can be designed to change the stroke value or length without having to change the direction of the motor.

In still yet another and/or alternative non-limiting aspect of the present invention, the reciprocating saw optionally includes a gearing arrangement that includes an eccentric cam arrangement to enable two reciprocating saw blades to reciprocate in opposite directions during the operation of the reciprocating saw. As can be appreciated, the gearing arrangement can include other arrangements that are absent an eccentric cam arrangement to enable two reciprocating saw blades to reciprocate in opposite directions during the operation of the reciprocating saw.

In another and/or alternative non-limiting aspect of the present invention, the reciprocating saw can include a shoe that is used to facilitate in the use of the reciprocating saw. The configuration of the shoe is non-limiting. The shoe is generally positioned on the front end of the reciprocating saw. In one non-limiting embodiment of the invention, the shoe, when used, can be designed to be detachable from the body of the reciprocating saw; however, this is not required. In still another and/or alternative non-limiting embodiment of the invention, the shoe, when used, can be tiltable/pivotable to allow for angled cutting of the material by the one or more reciprocating saw blades; however, this is not required.

In still another and/or alternative non-limiting aspect of the present invention, the reciprocating saw can include one or more of the following features and/or advantages:
The reciprocating saw can be used with two reciprocating saw blades.
The reciprocating saw blades can include teeth that allow the cutting action to be performed on both the forward and return stroke; however, this is not required.
The reciprocating saw blades can include custom blade and/or tooth designs for use on or with a variety of materials.
The reciprocating saw blades can be designed to move in an opposed reciprocating motion, and/or move in an orbiting or elliptical motion.
The reciprocating saw blades can result in an opposed cutting force to thereby balance the cutting action of the reciprocating saw.
The reciprocating saw can be designed to improve accuracy, provide smoother cuts on work surfaces, and/or reduce fatigue on user.

The reciprocating saw can be designed to enable a user to attach or remove the reciprocating saw blades from the blade holders.
The reciprocating saw can be made from a variety of materials, including but not limited to metal, plastic, aluminum or recyclable material.
The reciprocating saw can be designed to enable the forwarding and reversing the motor to thereby change the stroke length of the reciprocating saw blades.
The reciprocating saw can be designed to include a rotating handle.
The reciprocating saw can be designed to include a pivoting handle.
The reciprocating saw can be designed to be a handheld tool.
The reciprocating saw can be designed to include one or more electric motors.
The reciprocating saw can be designed to include reciprocating saw blades that include a generally repeating V-shape teeth, W-shape teeth, alternating V-shape and W-shaped teeth, etc.
The reciprocating saw can be designed to include reciprocating saw blades that have blade teeth on one or both sides of one or both reciprocating saw blades.
The reciprocating saw can be designed to include reciprocating saw blades that have blade teeth and wherein every other tooth is angled outwardly.
The reciprocating saw can be designed to include reciprocating saw blades that have blade teeth and wherein one or more teeth are both angled and tapered.
The reciprocating saw can be designed to include reciprocating saw blades that have a blade tooth configuration that inhibits or prevent the two reciprocating saw blades form separating from one another during the operation of the reciprocating saw.
The reciprocating saw can be designed to include reciprocating saw blades that include one or more blade separators to maintain the spacing of the reciprocating saw blades from one another during the operation of the reciprocating saw blades.

It is one non-limiting object of the present invention to provide a multi-blade reciprocating saw.

It is another and/or alternative non-limiting object of the present invention to provide a multi-blade reciprocating saw wherein two or more reciprocating saw blades reciprocate in the opposite direction from one another.

It is still another and/or alternative non-limiting object of the present invention to provide a reciprocating saw that is dedicated to the use with one or more reciprocating saw blades.

It is yet another and/or alternative non-limiting object of the present invention to provide a reciprocating saw that improves the cutting of material by the reciprocating saw blades.

It is still yet another and/or alternative non-limiting object of the present invention to provide a reciprocating saw that reduces the vibration caused by the cutting of material by the reciprocating saw blades and/or operation of the reciprocating saw and thereby reduce fatigue to the user when using the reciprocating saw and/or facilitate in the ease, quality and/or accuracy of a cut in a material during the use of the reciprocating saw.

It is another and/or alternative non-limiting object of the present invention to provide a reciprocating saw that improves in the speed and/or accuracy of the cutting operation through a material.

It is still another and/or alternative non-limiting object of the present invention to provide a reciprocating saw that reduces the forward/backward or rearward forces on the user when using the reciprocating saw to cut through material and thereby reduce fatigue to the user when using the reciprocating saw and/or facilitate in the ease, quality and/or accuracy of a cut in a material during the use of the reciprocating saw.

It is yet another and/or alternative non-limiting object of the present invention to provide a reciprocating saw that reduces of the jerking actions caused by the reciprocating saw blades during the cutting operation and thereby reduce fatigue to the user when using the reciprocating saw and/or facilitate in the ease, quality and/or accuracy of a cut in a material during the use of the reciprocating saw.

It is still yet another and/or alternative non-limiting object of the present invention to provide a reciprocating saw that improves in the accuracy of the cutting operation through material.

It is another and/or alternative non-limiting object of the present invention to provide a reciprocating saw that provides for a smoother cuts and/or less abrupt cut through the material.

It is still another and/or alternative non-limiting object of the present invention to provide a reciprocating saw wherein the speed or rate of reciprocation of the two reciprocating saw blades when reciprocating in opposite directions can be the same or different.

It is yet another and/or alternative non-limiting object of the present invention to provide a reciprocating saw wherein the two reciprocating saw blades can have the same or dilterent length, tooth location and/or shape.

It is still yet another and/or alternative non-limiting object of the present invention to provide a reciprocating saw wherein the connection arrangement of the two reciprocating saw blades can be the same or different.

It is another and/or alternative non-limiting object of the present invention to provide a reciprocating saw that includes a quick connect/release arrangement for one or both reciprocating saw blades.

It is still another and/or alternative non-limiting object of the present invention to provide a reciprocating saw that the configuration of the cutting teeth on the first and second reciprocating saw blades can be the same or different.

It is yet another and/or alternative non-limiting object of the present invention to provide a reciprocating saw that one or more teeth on one or both of the reciprocating saw blades angle outwardly from the central cutting axis of the reciprocating saw so as to cause one or both reciprocating saw blades to move toward one another during the cutting of material, to facilitate in the movement and to inhibit or prevent blade separation during the operation of the reciprocating saw.

It is still yet another and/or alternative non-limiting object of the present invention to provide a reciprocating saw that includes gearing that enables the two reciprocating saw blades to be reciprocated in opposite directions at the same or different speeds.

It is another and/or alternative non-limiting object of the present invention to provide a reciprocating saw that includes a laser or light switch to activate and/or deactivate one or more lights or lasers on the reciprocating saw.

It is still another and/or alternative non-limiting object of the present invention to provide a reciprocating saw that includes a shoe.

It is yet another and/or alternative non-limiting object of the present invention to provide a reciprocating saw that includes a shoe that can be tiltable to allow for angled cutting of the material by the one or more reciprocating saw blades.

It is still yet another and/or alternative non-limiting object of the present invention to provide a reciprocating saw that includes a connector arrangement that connects the two reciprocating saw blades together and enables the two reciprocating saw blades to reciprocate in opposite directions.

It is another and/or alternative non-limiting object of the present invention to provide a reciprocating saw that includes a gearing arrangement that enables the user to select a plurality of stroke options for the one or more reciprocating saw blades.

It is still another and/or alternative non-limiting object of the present invention to provide a reciprocating saw that includes a gearing arrangement that includes an eccentric cam arrangement to enable two reciprocating saw blades to reciprocate in opposite directions during the operation of the reciprocating saw.

It is yet another and/or alternative non-limiting object of the present invention to provide a reciprocating saw that includes a handle that can be pivoted and/or rotated relative to the longitudinal axis of the body of the reciprocating saw.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 is a side elevation view of one non-limiting reciprocating saw that includes two reciprocating saw blades in accordance with the present invention;

FIG. 2 is an opposite side elevation view of the reciprocating saw of FIG. 1;

FIG. 3 is a rear end view of the reciprocating saw of FIG. 1;

FIG. 4 is a top plan view of the reciprocating saw of FIG. 1;

FIG. 5 is a side view of another non-limiting reciprocating saw that includes two reciprocating saw blades and a pivoting and rotatable handle in accordance with the present invention;

FIG. 6 is a side view of the reciprocating saw of FIG. 5 showing the handle pivoted in a different position and rotated in a different position;

FIG. 7 is a side elevation view of the reciprocating saw of FIG. 6;

FIG. 8 is a front elevation top view of one non-limiting the gear arrangement of the reciprocating saw in accordance with the present invention;

FIG. 9 is a front elevation bottom view of the non-limiting the gear arrangement of FIG. 8;

FIG. 10 is a bottom plan view of the non-limiting gear arrangement of FIG. 8;

FIG. 11 is an exploded view of the non-limiting gear arrangement of FIG. 8;

FIG. 12 is a front elevation top view of the non-limiting gear arrangement of FIG. 8 without the gear housing;

FIG. 13 is a bottom plan view of the non-limiting gear arrangement of FIG. 12;

FIG. 14 is a front elevation top view of another non-limiting gear arrangement of the reciprocating saw in accordance with the present invention;

FIG. 15 is a side view of the non-limiting gear arrangement of FIG. 14 without the gear housing;

FIG. 16 is an exploded view of the non-limiting gear arrangement of FIG. 14;

FIG. 17 is a front elevation top view of the non-limiting gear arrangement of FIG. 14 without the gear housing;

FIG. 18 is a front elevation top view of the non-limiting gear arrangement of FIG. 14 without the gear housing and the drive gear to show operation of the dual stroke gear arrangement during clockwise rotation;

FIG. 19 is front elevation top view of the non-limiting the gear arrangement of FIG. 14 without the gear housing and the drive gear to show operation of the dual stroke gear arrangement during counterclockwise rotation;

FIG. 20 is a front elevation view of one non-limiting blade disconnect arrangement in accordance with the present invention;

FIG. 21 is a cross-sectional view of the blade disconnect arrangement of FIG. 20;

FIG. 22 is a side view of the blade disconnect arrangement of FIG. 20;

FIG. 23 is a front elevation view of one non-limiting right side reciprocating saw blade in accordance with the present invention;

FIG. 24 is a front view of the reciprocating saw blade of FIG. 23;

FIG. 25 is a front elevation view of one non-limiting left side reciprocating saw blade in accordance with the present invention;

FIG. 26 is a front view of the reciprocating saw blade of FIG. 25;

FIG. 27 is an enlarged side view of the blade teeth of the reciprocating saw blade of FIG. 25;

FIG. 28 is a front elevation view of another non-limiting right side reciprocating saw blade in accordance with the present invention;

FIG. 29 is a side view of another non-limiting embodiment of a left side reciprocating saw blade in accordance with the present invention;

FIG. 30 is a cross-sectional view along line 30-30 of FIG. 29;

FIG. 31 is a cross-sectional view along line 31-31 of FIG. 29;

FIG. 32 is side view of another non-limiting embodiment of a right side reciprocating saw blade in accordance with the present invention;

FIG. 33 is the opposite side view of the right side reciprocating saw blade of FIG. 32;

FIG. 34 is a cross-sectional view along line 34-34 of FIG. 32;

FIG. 35 is an elevation view of the reciprocating saw blades illustrated in FIGS. 29, 32 and 33;

FIG. 36 is an elevation view of the reciprocating saw blades illustrated in FIGS. 29, 32 and 33 connected together;

FIG. 37 is a cross-sectional view along line 37-37 of FIG. 36;

FIG. 38 is a side view of another non-limiting right side reciprocating saw blade in accordance with the present invention;

FIG. 39 is a bottom view of the reciprocating saw blade of FIG. 38;

FIG. 40 is a side view of another non-limiting left side reciprocating saw blade in accordance with the present invention;

FIG. 41 is a bottom view of the reciprocating saw blade of FIG. 40;

FIG. 42 is a side view of another non-limiting left side reciprocating saw blade in accordance with the present invention; and,

FIG. 43 is a bottom view of the reciprocating saw blade of FIG. 42.

### DETAILED DESCRIPTION OF NON-LIMITING EMBODIMENTS

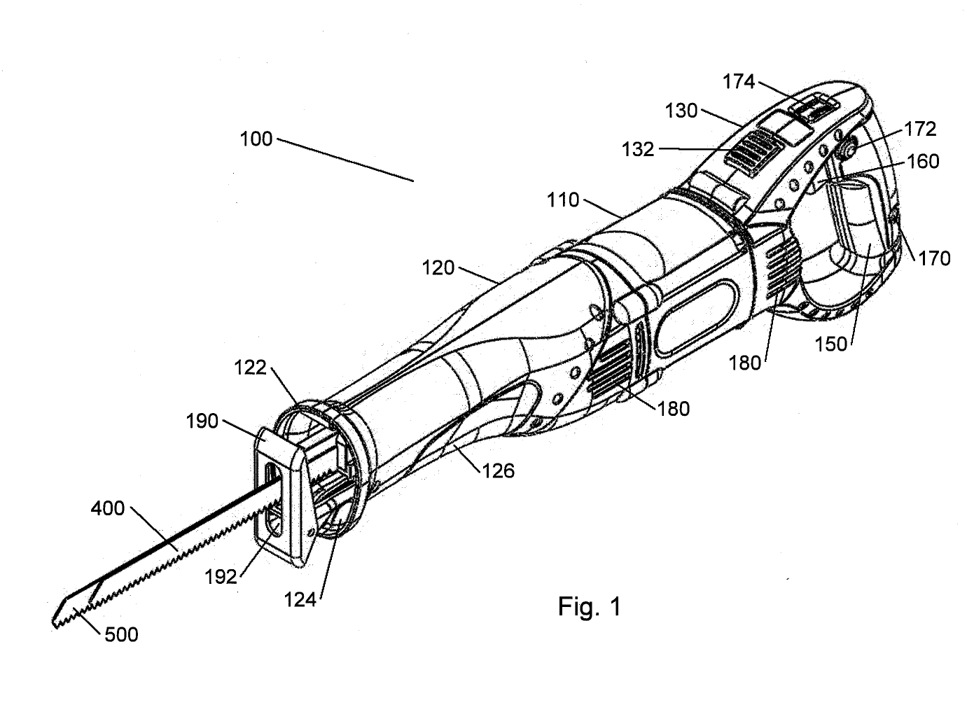

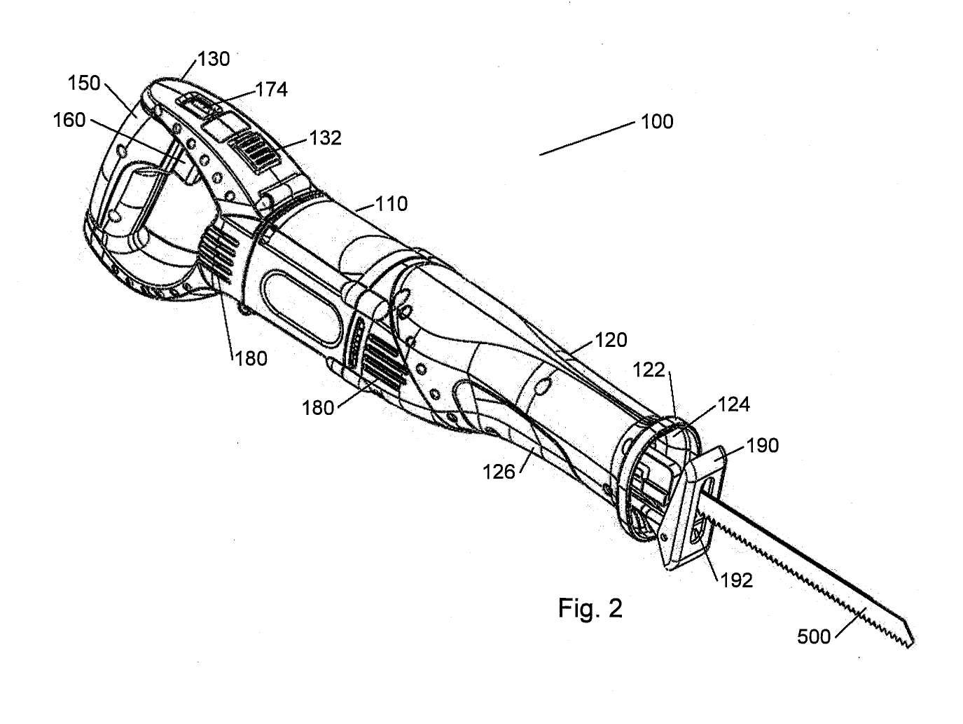

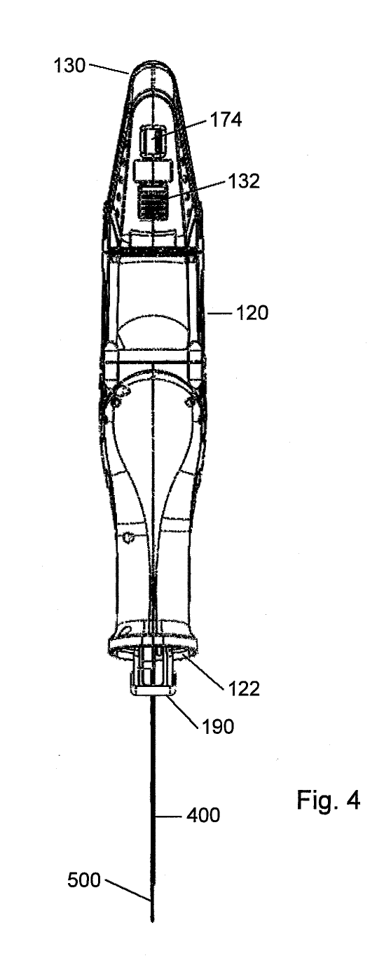

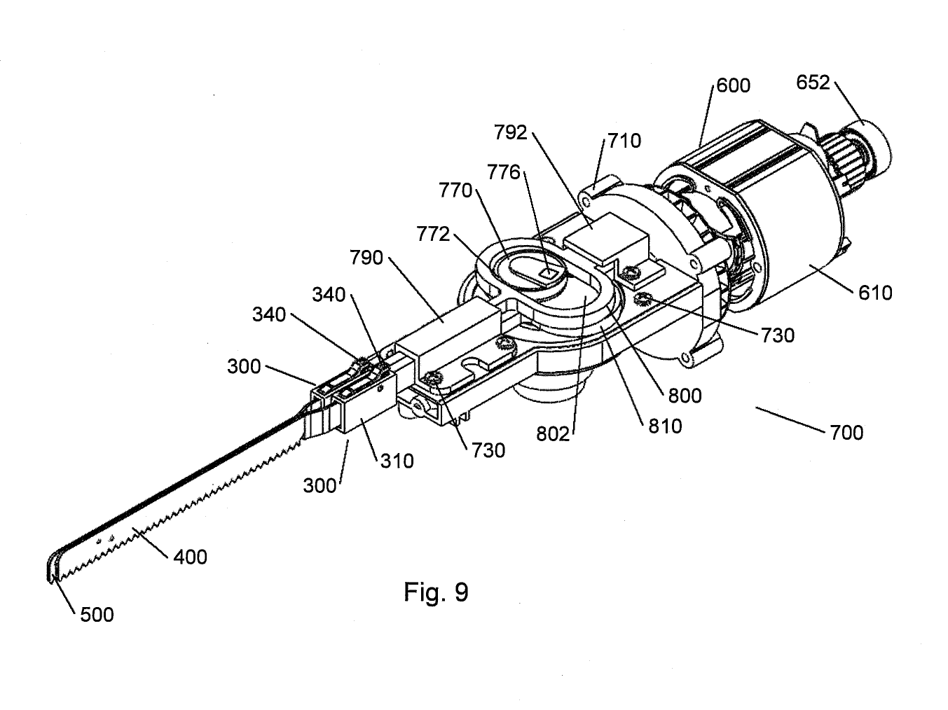

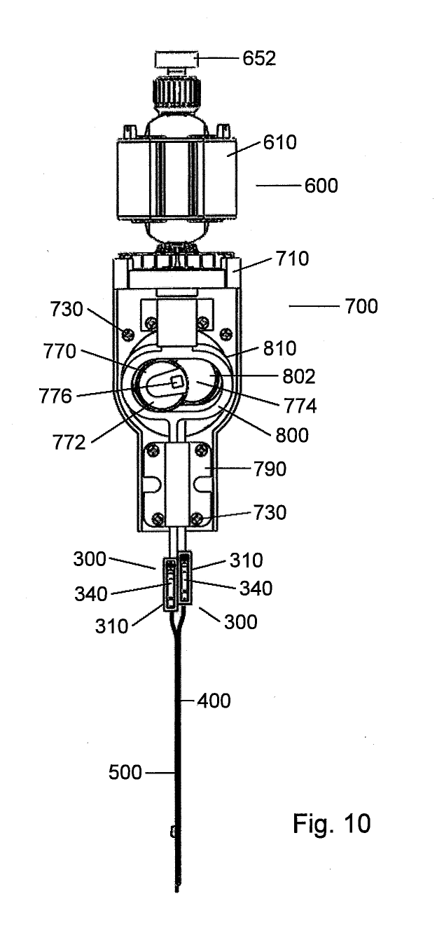

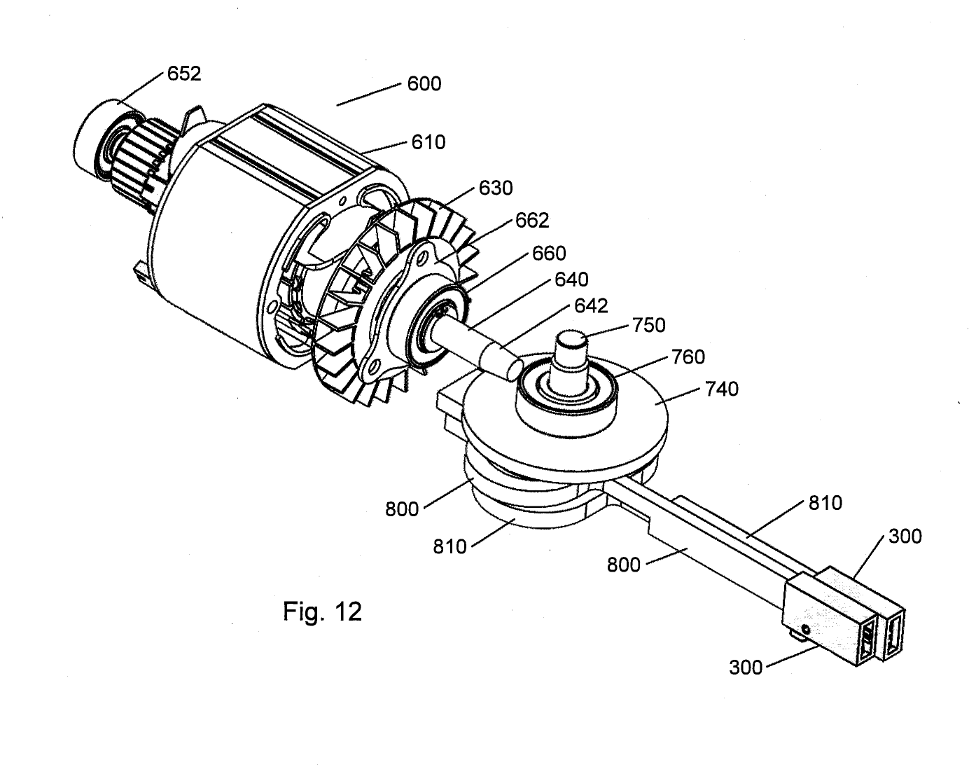

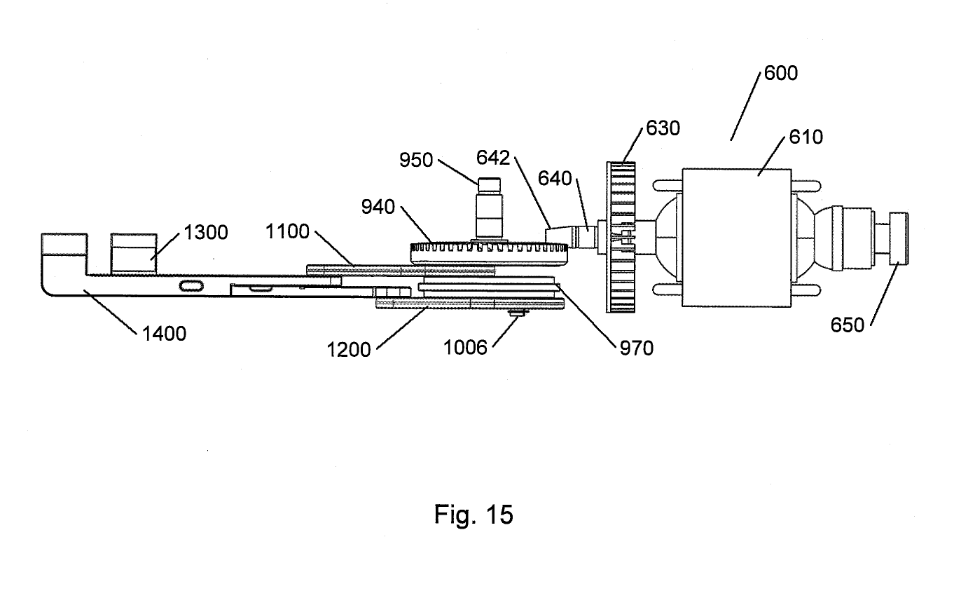

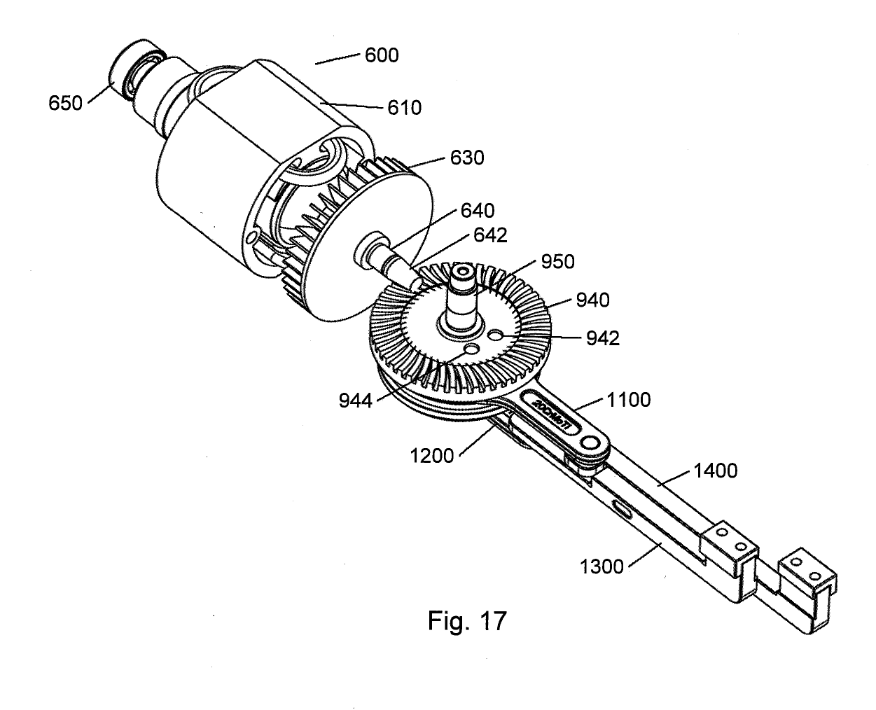

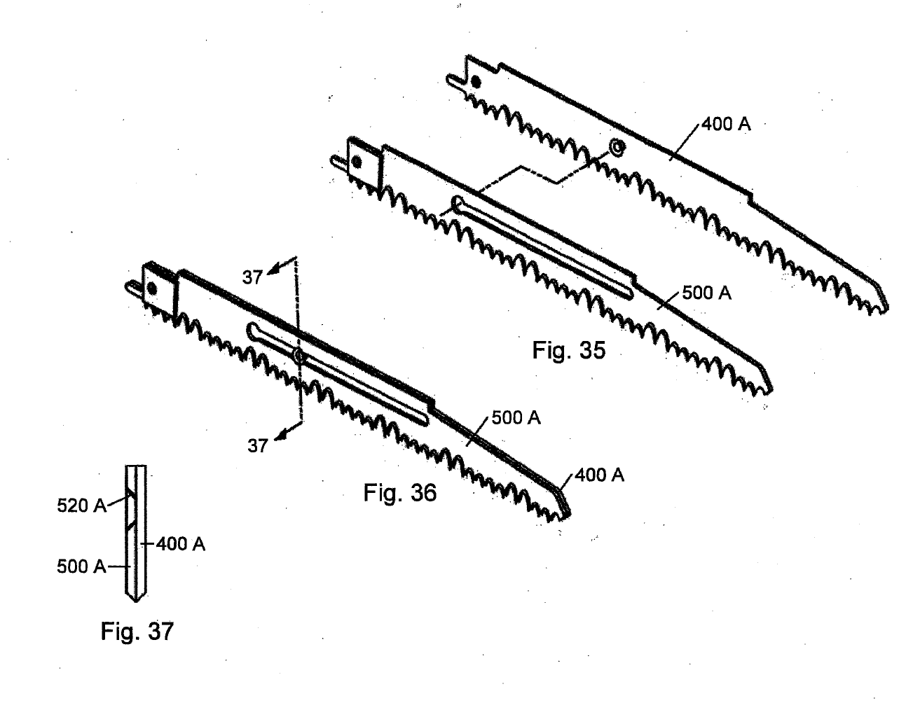

Referring now to the drawings wherein the showings are for the purpose of illustrating one non-limiting embodiment of the invention only and not for the purpose of limiting same, FIGS. 1-43 illustrate non-limiting embodiments of the reciprocating saw in accordance with the present invention.

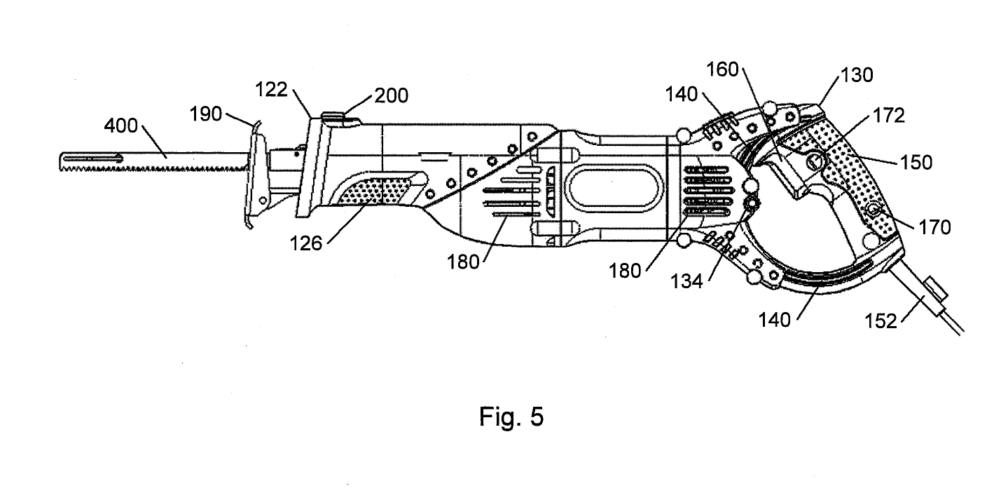

FIGS. 1-4 illustrate one non-limiting body 110 of a reciprocating saw 100 in accordance with the present invention. FIGS. 5-7 illustrate another non-limiting body 110 of a reciprocating saw 100 in accordance with the present invention. The two bodies of the reciprocating saw are similar; however, the non-limiting body of a reciprocating saw illustrated in FIGS. 5-7 has a handle 130 than can pivot and rotate relative to the main body portion 120 of the body of the reciprocating saw. The handle 130 of the body of the reciprocating saw illustrated in FIGS. 1-4 is fixed or can only rotate relative to the main body portion 120 of the body 110 of the reciprocating saw 100. The shape of the body of the reciprocating saw 100 is non-limiting. As can be appreciated, the color of the reciprocating saw and the materials used to make the reciprocating saw are non-limiting. The main body portion and/or the handle can be formed of one or more parts. When the main body portion and/or the handle are formed of more than one part, the parts can be connected together by a variety of means (e.g., adhesive, solder bond, melt bond, weld bead, rivet, screw, nut and bolt, snap lock arrangement, clamp arrangement, etc.). As illustrated in FIGS. 1-7, reciprocating saw 100 is designed to be a handheld power tool; however, it can be appreciated that reciprocating saw 100 can be designed to be secured to a robotic or fixed to some type of machine.

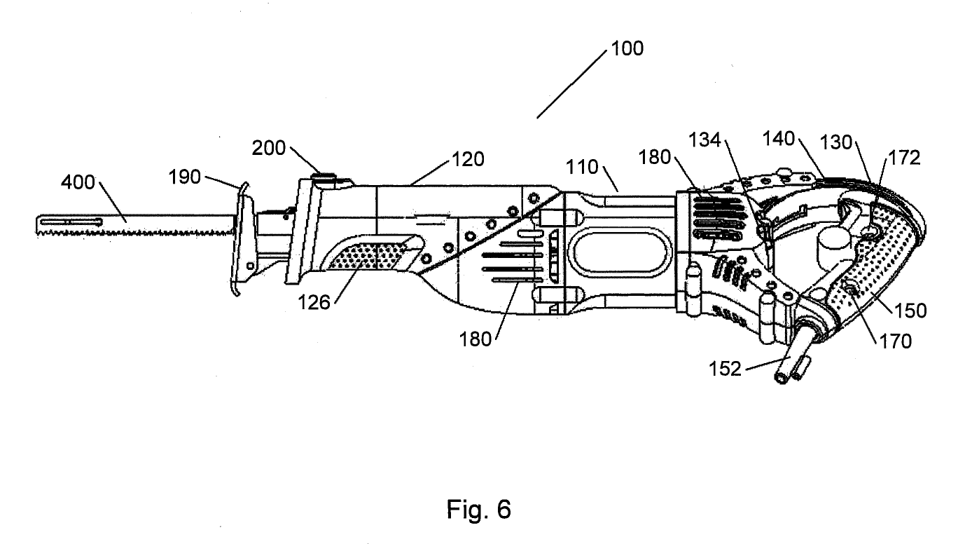

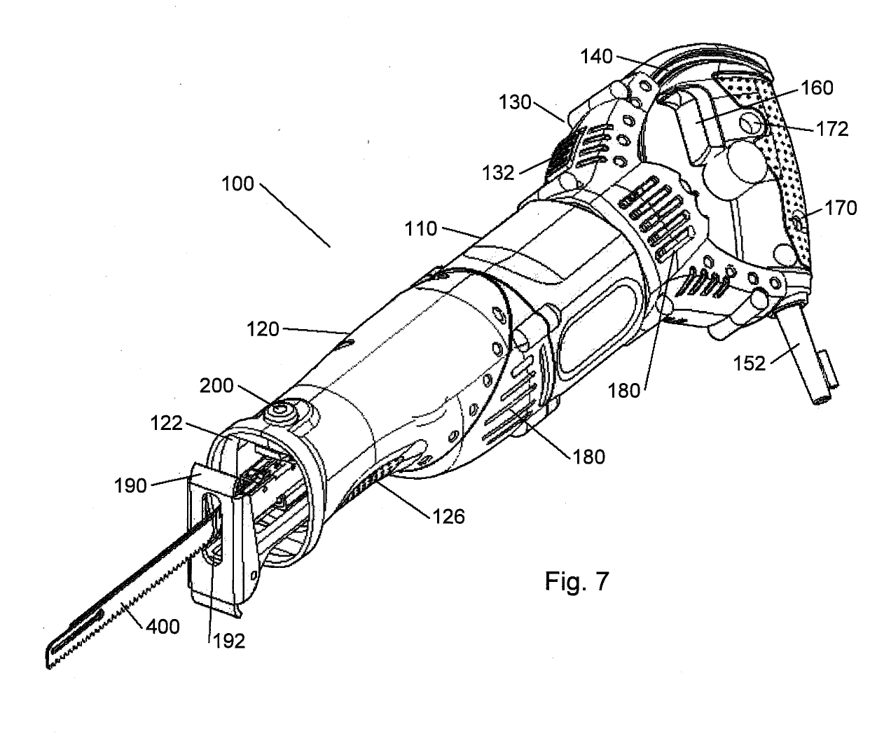

Referring again to FIGS. 1-7, the handle 130 is designed to enable a user to grasp the reciprocating saw at one end during use. The configuration of the handle is non-limiting. Handle 130 can optionally include a rotate button 132 that enables the handle to be rotated relative to the main body portion of the reciprocating saw. As can be appreciated, the size, shape, operation, and location of the rotate button is non-limiting. As can also be appreciated, the rotate button can be positioned on the main body portion 120 instead of handle 130. FIGS. 6 and 7 illustrated the handle in a rotated position. FIGS. 1-5 illustrate the handle in a non-rotated position. The handle can be designed to be rotated between two different positions or a plurality of different positions. Generally, when the handle is in a non-rotated position, the degree of rotation is considered to be a 0 position. When the handle is designed to be rotated in four positions, such positions are generally the 0°, 90°, 180° and 270° positions. As can be appreciated, the handle can be designed to be positioned in other or additional positions (e.g., 30°, 60°, 120°, 150°, 210°, 240°, 300°, 330°, etc.). Generally, the button is designed to be depressed to release a handle locking mechanism to thereby allow the handle to be rotated to a desired position. The release or movement of the button to its original position can be designed to result in the locking of the handle in position. When the handle is designed to be also or alternatively pivot, a pivot button 134 can be located in the handle or on the main body portion. As can be appreciated, the size, shape, operation, and location of the pivot button are non-limiting. FIG. 5 illustrates the handle pivoted in a slightly forward position. FIGS. 6 and 7 illustrate the handle pivoted in a fully rearward position. The handle can optionally include a slot 140 that facilitates in the pivoting movement of the handle; however, other or additional arrangements can be used to facilitate in the pivoting of the handle. The handle, when pivotable, can be designed to be moved at certain set pivoting angles; however, this is not required.

The handle can optionally include a gripping surface 150 to facilitate in the gripping of the reciprocating saw by the user. The type of material, location of the grip on the handle, the style of the grip, and the configuration of the grip are non-limiting. The main body portion can also optionally include a gripping surface 126; however, this is not required. For example, all or a portion of the front of the main body portion of the body of the reciprocating saw can be covered with, or include a soft gripping material and/or other type of gripping material. Such gripping material can be used to facilitate in grasping and/or guiding the reciprocating saw during use and/or to reduce vibration to the user during the use of the reciprocating saw. The gripping material on the main body portion and the handle can be made of the same or different material and/or have the same or different surface gripping features.

The reciprocating saw can be powered by a battery, a power cord, etc. When the reciprocating saw is powered by a battery, the battery can be a rechargeable battery, a removable battery, etc.; however, this is not required. The one or more batteries, when used, can be located in the handle and/or main body portion. When the reciprocating saw is powered by a power cord 152, the power cord is generally connected to the handle; however, this is not required. As can be appreciated, the size, shape and location of the one or more batteries, when use, are non-limiting.

The handle generally includes a power button 160 that is used to activate the one or more electric motors that are located partially or fully within the body of the reciprocating saw. The size, location and orientation of the one or more motors in the body of the reciprocating saw is non-limiting. The speed at which the one or more motors operate is also non-limiting. The power button is generally a depressible button. As can be appreciated, other or additional types of activation arrangements (e.g., slide switch, etc.) can be used to activate/deactivate the one or more motors in the body of the multi-blade reciprocating saw. As can be appreciated, the size, shape, operation, and location of the power button are non-limiting. The power button can be designed to vary the speed of the one or more electric motors based on the amount the power button is depressed by the user; however, this is not required. As such, the reciprocating saw can be a multi-speed reciprocating saw or a single speed reciprocating saw. A lock button 172 can optionally be positioned on the handle and/or main body portion of the reciprocating saw to prevent the depression of the power button and/or to lock the power button is an “on” position. As can be appreciated, the size, shape, operation, and location of the lock button are non-limiting.

The handle or main body portion of the reciprocating saw can include a stroke adjustment button 174. As will be described in more detail below, the reciprocating saw can be designed to be a single stroke reciprocating saw or a multi-stroke reciprocating saw. When the reciprocating saw is a multi-stroke reciprocating saw, a button, knob, switch or the like can be used to select the available stroke options of the reciprocating saw. The size, shape, operation and location of the button, knob, switch, etc. on the handle or main body portion of the reciprocating saw is non-limiting. As illustrated in FIGS. 1-3, a stroke adjustment button 174 is located on the handle of the reciprocating saw.

The main body portion can optionally include one or more vent openings 180 to allow for air flow into and/or out of the interior of the main body to enable cooling of one or more components (e.g., motor, etc.) in the main body. The number, shape and/or location of the one or more vent openings on the main body portion of the reciprocating saw are non-limiting.

A shoe 190 can be connected to the front end 122 of the main body portion; however, this is not required. The shoe, when used, can function as a position guide during the cutting of material. The shoe can also or alternatively be used to protect the front end 122 from damage during the cutting of material and/or to limit the amount of material that enters a cavity 124 in the front end 122 of the main body portion of the reciprocating saw portion; however, this is not required. The shoe, when used, can function as a space limiter to ensure proper spacing of the front end 122 from the material to be cut and/or to ensure the desired blade portion of the reciprocating saw blades is used to cut material; however, this is not required. As can be appreciated, the shoe can have other or additional functions. The shape of the shoe is non-limiting. The shoe generally includes an opening 192 or slot to enable the reciprocating saw blades to pass through the shoe. The shoe can be movably connected to front end 122 or be non-movably connected to front end 122. The opening or slot in the shoe can be shaped and/or markers can be positioned about the opening or slot to function as a guide or a positioning feature to enable the user to cut a material in a desired location; however, this is not required. When a light and/or laser is used on the reciprocating saw, the light and/or laser can be directed to shine light into and/or about an opening or slot; however, this is not required.

The reciprocating saw can include a quick blade release button 200; however, this is not required. The quick blade release button 200, when used, can be positioned near the front end of the main body portion; however, this is not required. As can be appreciated, the size, shape, operation, and location of the quick blade release button are non-limiting. In operation, the quick blade release button is typically depressed so as to cause the reciprocating saw blades to become unlocked and removable from the main body portion of the reciprocating saw; however, this is not required. The quick blade release button can also be designed to be depressed so as to allow the reciprocating saw blades to be connected to the main body portion of the reciprocating saw; however, this is not required. The type of quick disconnect arrangement used for the blades is non-limiting.

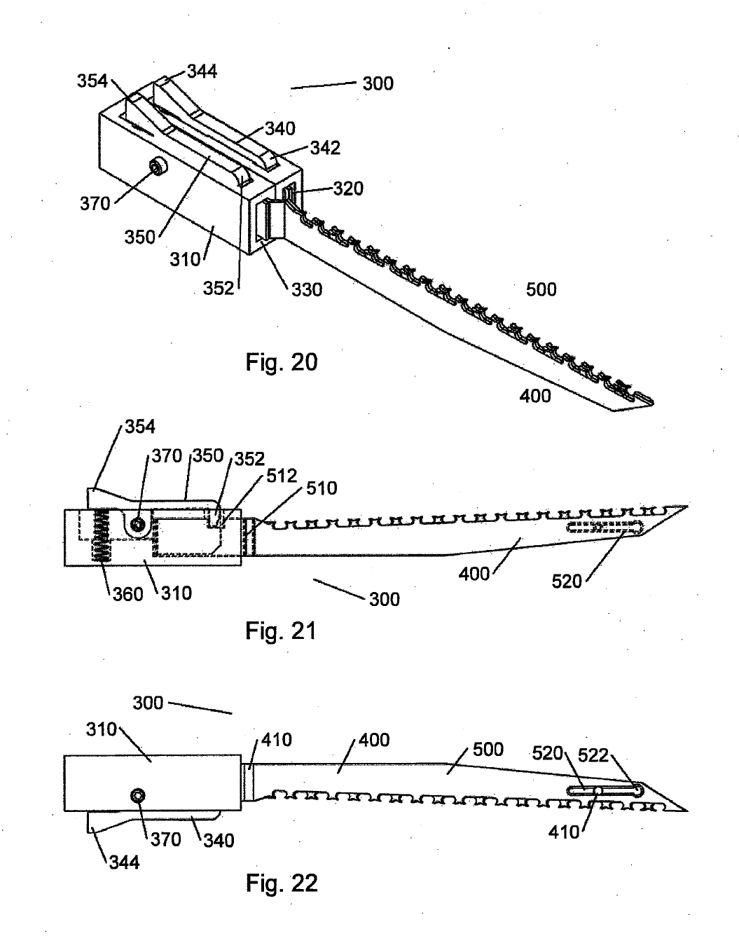

FIGS. 20-25 illustrate one non-limiting quick disconnect arrangement 300 that can be used. Such a quick disconnect arrangement is one non-limiting configuration for a tool-less blade removal system that can be used with the reciprocating saw. The quick disconnect arrangement includes a housing 310 that includes two front openings 320, 330. Each front opening is designed to receive a rear portion 410, 510 of a reciprocating saw blade 400, 500. The rear portion of the saw blades can include a connection notch 412, 512 that is designed to engage a lock finger 342, 352 of pivot arms 340, 350 of the quick disconnect arrangement. The pivot arms can be biased by a spring 360 or other means in a locked position as illustrated in FIG. 21. The pivot arms can be designed to pivot on a pivot pin 370 or on some other means. The pivot arms can optionally include a raised back portion 344, 354 that can be caused to be pushed downwardly when the quick blade release button 200 is depressed by a user. When the raised back portions 344, 354 of the pivot arms are pushed downwardly, the lock fingers 342, 352 of pivot arms 340, 350 are caused to lift from the connection notches 412, 512 of the two reciprocating saw blades, thereby enabling the reciprocating saw blades to be removed from housing 310. As can be appreciated, the lifting of the lock fingers 342, 352 of pivot arms can also be used to enable the two reciprocating saw blades to be inserted into housing 310. Once the blades are inserted, the quick blade release button 200 is released and spring 360 causes the lock fingers 342, 352 of pivot arms 340, 350 to lower into the connection notches 412, 512 of the two reciprocating saw blades to thereby lock the two reciprocating saw blades in housing 310 of the quick disconnect arrangement. As can be appreciated, other arrangements can be used to quickly connect and/or disconnect one or both reciprocating saw blades from the main body portion of the reciprocating saw.

As can be appreciated, a quick disconnect arrangement is not required for use on the reciprocating saw. When a quick disconnect arrangement is not used, the one or more reciprocating saw blades can be connected/disconnected from the main body of the reciprocating saw by use of washers, hex screws, etc. which require tools (e.g., screw driver, pliers, wrench, etc.) to remove and/or attach one or both reciprocating saw blades to the main body of the reciprocating saw.

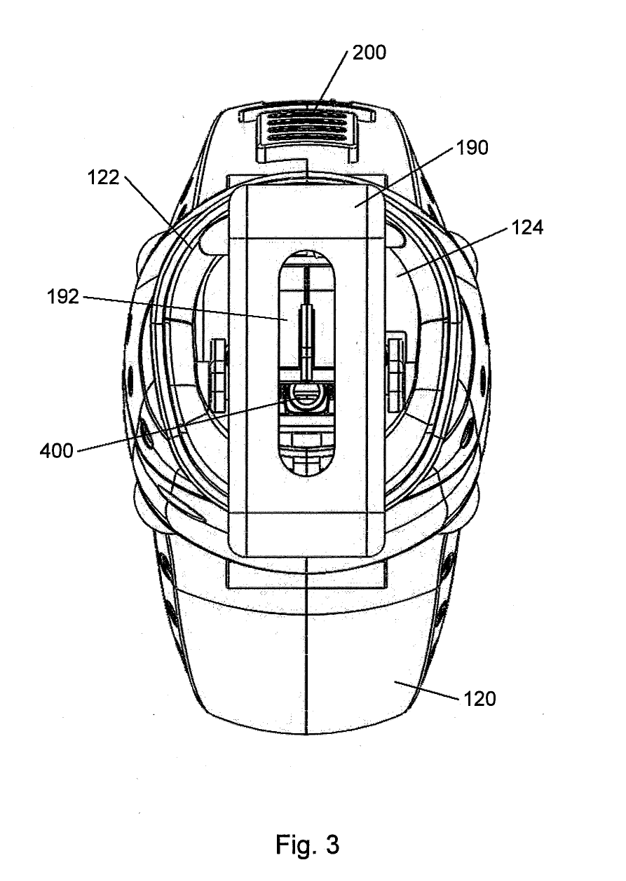

The reciprocating saw can include a light or laser 401 that can be used to guide the reciprocating saw blades during the cutting of material and/or illuminate the material during the cutting of the material. The light or laser 401 can be activated by a switch that is located on the handle and/or main body portion of the reciprocating saw. In one non-limiting arrangement, the switch is positioned beneath the surface of the handle and is designed to be activated and cause the light or laser 401 to illuminate when a user grasps the handle and to turn off when the user releases the handle; however, this is not required. Alternatively, a switch 170 can be positioned on the handle or main body portion to enable a user to manually activate/deactivate the light or laser. As illustrated in FIGS. 5-7, switch 170 is positioned on the side of the handle. As can be appreciated, the size, shape, operation, and location of switch 170 are non-limiting. As illustrated in FIG. 3, the light or laser 401 is positioned so as to direct light at or through the opening 192 in shoe 190; however, this is not required. As can be appreciated, the light or laser can be positioned above or below the shoe, or on the top, bottom or one or both side surfaces of the main body portion. As can be appreciated, the dual reciprocating saw can include a light and laser, multiple lights, and/or multiple lasers.

As illustrated in FIGS. 1, 2, 4-11, and 20-43 various types of reciprocating saw blades can be used with the reciprocating saw. Different types of reciprocating saw blades can be configured to facilitate in the cutting of different types of material. Although all of the illustrated blades are shown to include teeth on one side of the reciprocating saw blades; it will be appreciated that teeth can be positioned on both sides of the reciprocating saw blades. Not only can the general configuration of the reciprocating saw blades be specially configured, the tooth configuration on the reciprocating saw blades can also be customized for use in cutting different types of materials.

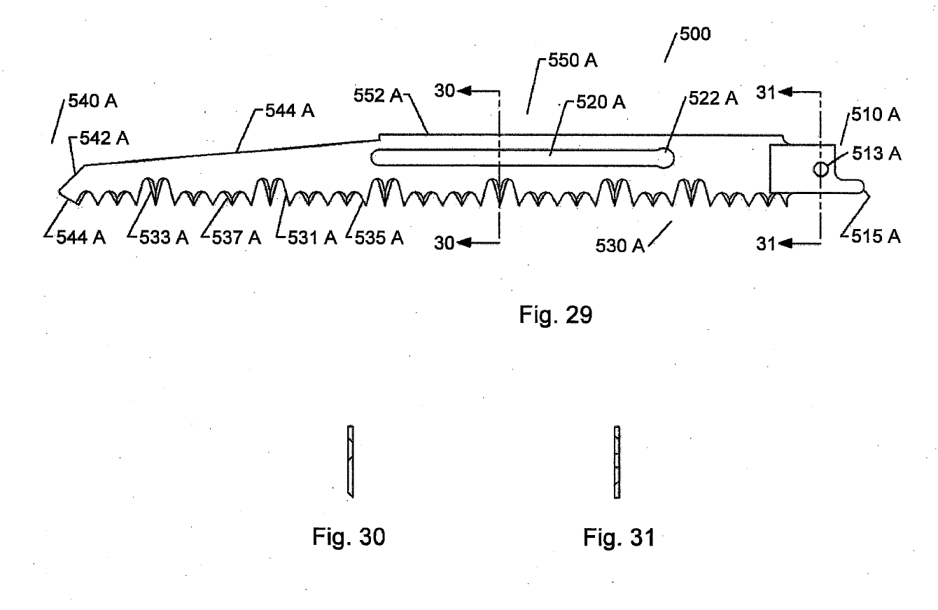

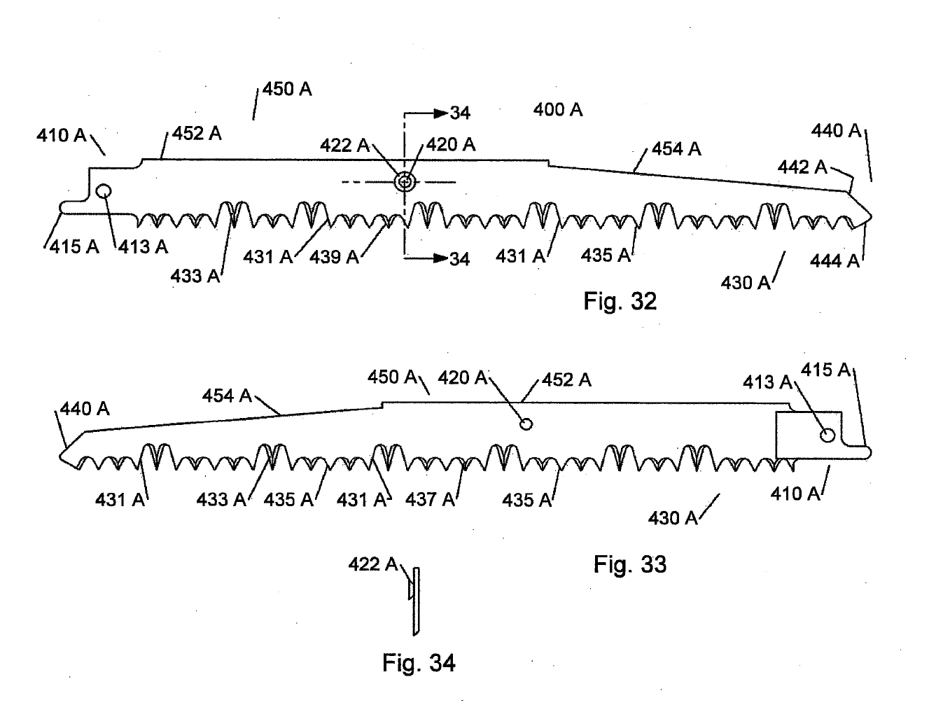

The reciprocating saw of the present invention can be use with one or two reciprocating saw blades 400, 500 or 400A, 500A or 400B, 500B, or 400B, 500C. When two reciprocating saw blades are used, the reciprocating saw blades may or may not be connected together. As illustrated in FIGS. 1, 2, and 4, reciprocating saw blades are not connected together. As illustrated in FIGS. 5-11 and 20-43, the reciprocating saw blades are connected together. Many different arrangements can be used to connect the reciprocating saw blades together. One non-limiting arrangement is a pin and slot arrangement. As illustrated FIGS. 5-11 and 20-43, reciprocating saw blade 400, 400A, 400B includes a pin 420, 420A, 420B that is designed to move within a slot 520, 520A, 520B, 520C in reciprocating saw blade 500, 500A, 500B, 500C. Pin 420, 420A, 420B can include an enlarged head 422, 422A, 422B to prevent the pin from disengaging from slot 520, 520A, 520B, 520C during the operation of the reciprocating saw; however, this is not required. Slot 520, 520A, 520B, 520C can include an enlarged opening 522, 522A, 522B, 522C to enable the pin head to be disengaged from slot 520, 520A, 520C, 520C; however, this is not required. One or both blades can include a spacer arrangement that maintains the distance of the reciprocating saw blades from one another during the operation of the reciprocating saw; however, this is not required. Many arrangements can be used for the spaces arrangement (e.g., rib, pin, roller bearing, etc.), when used on one or both reciprocating saw blades. As illustrated in FIG. 29, the majority of the slot is positioned on the back half of the reciprocating blade; however, this is not required. As illustrated in FIGS. 32 and 33, the pin head is positioned on the back half of the reciprocating saw blade; however, this is not required.

The configuration of the teeth 430, 430A, 430B, 530, 530A, 530B, 530C on the reciprocating saw blades 400, 400A, 500, 500A is non-limiting. The reciprocating saw blades may or may not include cutting teeth. The teeth on the reciprocating saw blades can be located on one side or both sides of the reciprocating saw blades. As illustrated in FIGS. 24 and 26, one or more teeth on the reciprocating saw blades can angle outwardly from the body of the reciprocating saw blades so as to extend beyond the body of the reciprocating saw blades; however, this is not required. As illustrated in FIGS. 29-43, the teeth on the reciprocating saw blades do not angle outwardly from the body of the reciprocating saw blades so as to extend beyond the body of the reciprocating saw blades. In one non-limiting reciprocating saw blade, every tooth angles outwardly so as to extend beyond the body of the reciprocating saw blades. In another non-limiting reciprocating saw blade, every other tooth angles outwardly so as to extend beyond the body of the reciprocating saw blades. In still another non-limiting reciprocating saw blade, every third or fourth tooth angles outwardly so as to extend beyond the body of the reciprocating saw blades. As can be appreciated, the teeth can be configured on one or both reciprocating saw blade so that the teeth angle outwardly so as to extend beyond the body of the reciprocating saw blades such that a wave or snake-like pattern is formed by the teeth along all or a portion of the longitudinal length of the reciprocating saw blade; however, this is not required. The degree that the one or more teeth angle outwardly is non-limiting. The degree that different teeth angle outwardly can be the same or different on each reciprocating saw blade. The teeth configuration and teeth angle on each of the two reciprocating saw blades can be the same or different along the longitudinal length of the reciprocating saw blades. Generally, when the teeth are optionally angled outwardly so as to extend beyond the body of the reciprocating saw blades, the tip of the tooth is off center of the longitudinal axis of the reciprocating saw blade by about 0.001-0.1 inches, typically about 0.005-0.05 inches, and more typically about 0.005-0.03 inches; however, it can be appreciated that different values can be used on the reciprocating saw blades.

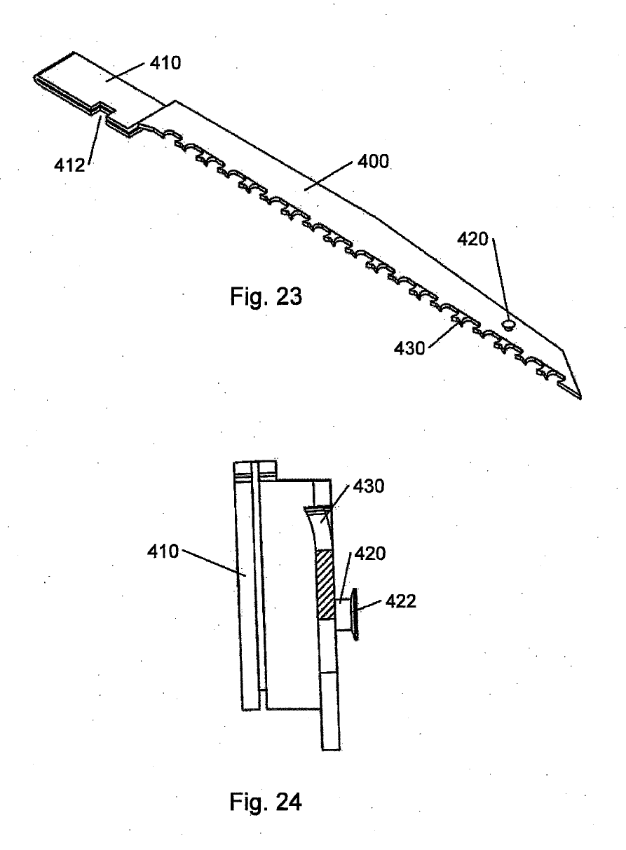

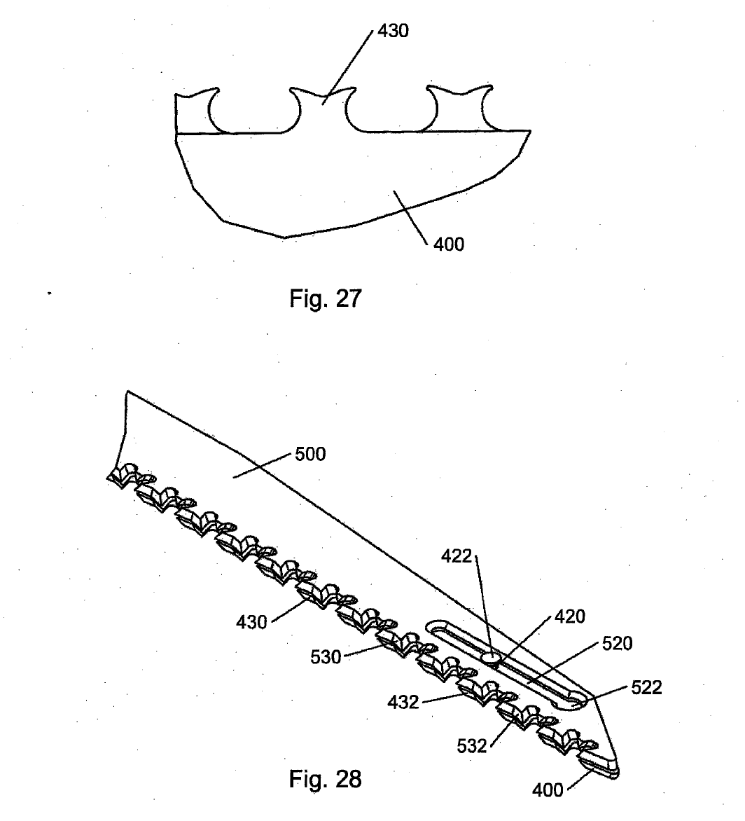

As illustrated in FIG. 27, one non-limiting side profile of a tooth configuration for one or both reciprocating saw blades is illustrated. The tooth is configured to include a forward and rearward facing cutting edge for cutting in both forward and backward movements of the reciprocating saw blades. The teeth have a general V-shaped profile; however other profiles can be used (e.g., W profile, inverted V-shape, inverted W-shape, M-shape, etc.). The tips of the teeth illustrated in FIG. 27 are rounded; however, it can be appreciated that the tips of one or more of the teeth can be pointed. As illustrated in FIG. 28, the side edges 432, 532 of the teeth are tapered; however, this is not required. The taper on the front and/or rear side edge of one or more teeth on one or both reciprocating saw blades can be used to 1) improve the cutting of material by one or both reciprocating saw blades, and/or 2) create an inward force that causes one or both reciprocating saw blades to move toward one another during the cutting of material; however, this is not required. As can be appreciated, tooth tapering can also be included on the blade teeth that are illustrated in FIGS. 23-27; however, this is not required. The taper, when used, can be on the front portion of the tooth, the back portion of the tooth, or on both the front and back portion. FIG. 28 illustrates the taper on both the front and back portion of the tooth. The taper, when use, is generally located on the outer side of the tooth as illustrated in FIG. 28; however, it can be appreciated that the taper can be located on the inner side of the tooth or on both the inner and outer side of the tooth. The top edge of one or more teeth can also include tapered surfaces. The top of the teeth illustrated in FIG. 28 are generally flat; however, it can be appreciated that the profile of the top of the teeth can have other profiles (e.g., V shaped, W shaped, inverted V-shape, inverted W-shape, M-shape, etc.). The height of the teeth on the reciprocating saw blades can be the same of different.

Referring now to FIGS. 29-37, reciprocating saw blades 400A, 500A each have a rear end portion 410A, 510A that is designed to be connected and disconnected from the reciprocating saw. The end portion including a connection opening 413A, 513A that enables a pin or other type of structure on the reciprocating saw to engage and secure the reciprocating saw blades to the reciprocating saw. The size and shape of the connection opening is non-limiting. The location of the connection opening on the end portion is non-limiting. Generally the opening is spaced from the end of the reciprocating saw blade; however, that is not required. As can be appreciated, the connection arrangement used on reciprocating blades 400A, 500A can be the same as for reciprocating blades 400, 500. The end portion can optionally include a leg 415A, 515A that can be used a guide and/or securing/positioning structure for securing the reciprocating saw blades to the reciprocating saw. The shape and/or size of the leg is non-limiting.

Referring again to FIGS. 29, 32 and 33, the teeth 430A, 530A have a special configuration designed to cut through various types of materials with little or no blade separation.

The spacing of the tips of adjacently positioned teeth is generally about 0.1-0.3 inches, typically 0.15-0.25 inches and more typically about 0.196 inches; however, other spacings can be used.

Generally the ratio of the spacing of tips of adjacently positioned teeth to the total length of the blade that includes teeth is about 0.01-0.1:1, typically about 0.01-0.05:1, more typically about 0.015-0.035:1, and still more typically about 0.02-0.03:1; however, other ratios can be used. The space of tips of adjacently positioned teeth can be uniformly or non-uniformity spaced from one another along the longitudinal length of the one or both reciprocating saw blades. As illustrated in FIGS. 29, 32 and 33, the spacing and teeth pattern of reciprocating saw blades 400A and 500A are generally the same; however, this is not required.

The tooth depth of the teeth on reciprocating saw blades 400A and 500A is illustrated as being non-uniform; however, this is not required. The reciprocating saw blades 400A and 500A each include teeth 431A, 531A having a deep tooth depth and teeth 435A, 535A having a shallower tooth depth. When the tooth depth is not uniform, the ratio of the shallow depth to the deeper depth is about 0.1-0.95:1, typically about 0.2-0.8:1, more typically about 0.3-0.7:1, still more typically about 0.4-0.6:1, and yet still more typically about 0.45-0.55:1; however, other ratios can be used. As illustrated in FIGS. 29, 32 and 33, only two different tooth depths exist on the reciprocating saw blade; however, it can be appreciated that more than two different depths can be included on one or both of the reciprocating saw blades (e.g., 3, 4, 5, 6, etc.).

The radius of curvature between adjacently positioned teeth can be the same or different along the longitudinal length of the one or both of the reciprocating saw blades. As illustrated in FIGS. 29, 32 and 33, the radius of curvature between the teeth having a deeper tooth depth is less than the radius of curvature between the teeth having the shallower tooth depth; however, this is not required. Generally, the ratio of the radius of curvature of the teeth having a deeper tooth depth to the radius of curvature between the teeth having the shallower tooth depth is about 0.5-1.5:1, typically about 0.6-1:1, more typically about 0.65-0.99:1, yet more typically about 0.7-0.9:1, and still more typically about 0.72-0.8:1; however, other ratios can be used. The radius of curvature is generally uniform between adjacently positioned teeth; however, this is not required.

As illustrated in FIGS. 29, 32 and 33, the reciprocating saw blade includes more teeth having the shallower tooth depth than teeth having the greater tooth depth; however, this is not required. As illustrated in FIGS. 29, 32 and 33, two to four teeth having the shallower tooth depth are positioned between teeth having the greater tooth depth; however, other numbers can be used. As also illustrated in FIGS. 29, 32 and 33, the teeth having the shallower tooth depth are positioned at the front end of the reciprocating saw blades; however, this is not required. As also illustrated in FIGS. 29, 32 and 33, the teeth having the shallower tooth depth are positioned at the back end of the reciprocating saw blades; however, this is not required.

The teeth can include a sloped face 433A, 437A, 533A, 537A; however this is not required. The angle of slope for the teeth can be the same or different. The angle slope can be on one or both sides of the teeth. The angle can be uniform or non-uniform along the length of each side of the tooth. The surface area of the sloped portion can be constant or vary along the length of each side of the tooth. In one embodiment, the slope angle on the teeth having a deeper tooth depth is less than the slope angle on the teeth having the shallower tooth depth; however, this is not required. In one non-limiting embodiment, the slope angle on the teeth having a deeper tooth depth is about 2-30°, typically about 5-25°, more typically about 10-20°, and even more typically about 12-18°; however, other angles can be used. In another non-limiting embodiment, the slope angle on the teeth having a shallower tooth depth is about 2-50°, typically about 5-40°, more typically about 10-35°, even more typically about 15-35°, still even more typically about 20-32°, and yet still even more topically about 25-30°; however, other angles can be used. The ratio of the slope angle on the teeth having a deeper tooth depth to the slope angle on the teeth having the shallower tooth depth is about 0.2-1.3:1, typically about 0.3-1:1, more typically about 0.30-0.95:1, still more typically about 0.35-0.9:1, yet still more typically about 0.4-0.75:1, and still yet more typically about 0.45-0.6:1; however, other ratios can be used.

The teeth can be oriented to be parallel to the longitudinal axis of the reciprocating saw blade or be at some angle to the longitudinal axis of the reciprocating saw blade. The angle of each of the teeth can be the same or different along the longitudinal axis of the reciprocating saw blade. As illustrated in FIGS. 29-37, the teeth are positioned at an angle to the longitudinal axis of the reciprocating saw blade. The teeth, when angled, two or more teeth can be angled the same direction or opposite direction. The teeth, when angled, can be optionally angled at the same or similar angle. When one or more of the teeth on the reciprocating saw blade are angled, the angle is generally about 2-40°, typically about 5-30°, and more typically about 15-30°; however, other angles can be used.

The tip of the teeth on the reciprocating saw blades generally lie in the same plane as illustrated in FIGS. 29, 32 and 33; however, this is not required. The tip 440A, 540A of the reciprocating saw blades can have a generally pointed shape. The slope angle on both sides of the tip can be the same or different. In one non-limiting embodiment, the slope angle on tip top surface 442A, 542A is greater than the slope angle on tip bottom surface 444A, 544A; however, this is not required. In one specific example, the slope angle on tip top surface for the reciprocating saw blades is about 30-60°, typically 35-55°, more typically about 40-50°; however, other angles can be used. In another specific example, the slope angle on tip bottom surface for the reciprocating saw blades is about 20-50°, typically 25-40°, more typically about 30-35°; however, other angles can be used. The top surface 450A, 550A of the reciprocating saw blades that is located on the opposite side of the tooth tips can be parallel or non-parallel to the plane of the tooth teeth. Generally, a majority of the top surface 450A, 550A of the reciprocating saw blades is parallel to the plane of the tooth teeth. As illustrated in FIGS. 29, 32 and 33, a portion of the top surface 450A, 550A of the reciprocating saw blades is parallel to the plane of the tooth teeth and another portion of the top surface 450A, 550A of the reciprocating saw blades is non-parallel to the plane of the tooth teeth. The length ratio of the portion of the top surface of the reciprocating saw blades that is parallel to the plane of the tooth teeth 454A, 554A to the other portion of the top surface 456A, 556A of the reciprocating saw blades that is non-parallel to the plane of the tooth teeth is about 0.9-100:1, typically 1-10:1, more typically about 1.01-10:1, still more typically about 1.05-4:1, yet more typically about 1.05-2:1, and still yet more typically about 1.1-1.5:1; however, other ratios can be used. The top portion of the reciprocating saw blades that is non-parallel to the plane of the tooth teeth is generally located at the front portion of the reciprocating saw blade; however, this is not required. The angle of the slope of the top portion of the reciprocating saw blades that is non-parallel to the plane of the tooth teeth is generally about 1-25°, typically about 2-20°, more typically about 2-10°, and still more typically about 3-7°; however, other angles can be used.

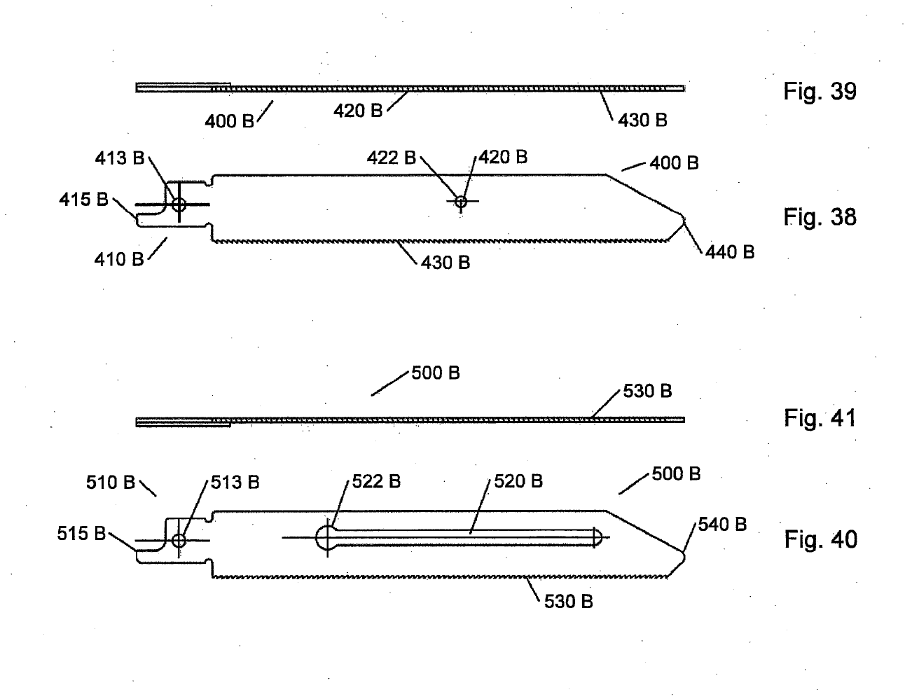

Referring now to FIGS. 38-43, reciprocating saw blades 400B, 500B, 500C each have a rear end portion 410B, 510B, 510C that is designed to be connected and disconnected from the reciprocating saw. The end portion including a connection opening 413B, 513B, 513C that enables a pin or other type of structure on the reciprocating saw to engage and secure the reciprocating saw blades to the reciprocating saw. The size and shape of the connection opening is non-limiting. The location of the connection opening on the end portion is non-limiting. Generally the opening is spaced from the end of the reciprocating saw blade; however, that is not required. As can be appreciated, the connection arrangement used on reciprocating blades 400B, 500B, 500C can be the same as for reciprocating blades 400, 500. The end portion can optionally include a leg 415B, 515B, 515C that can be used a guide and/or securing/positioning structure for securing the reciprocating saw blades to the reciprocating saw. The shape and/or size of the leg is non-limiting.

The teeth 430B, 530B, 530C have a special configuration designed to cut through hard materials such as steel, concrete, hard plastic and the like with little or no blade separation. The spacing of the tips of the teeth to adjacently positioned teeth is generally about 0.01-0.25 inches, typically 0.02-0.1 inches, more typically about 0.02-0.08 inches, and still more typically about 0.055 inches; however, other spacings can be used. Generally the ratio of the spacing of the tips of the teeth to adjacently positioned teeth to the total length of the blade that includes teeth is about 0.001-0.1:1, typically about 0.002-0.05:1, more typically about 0.004-0.025:1, and still more typically about 0.005-0.015:1; however, other ratios can be used. The space of tips of adjacently positioned teeth can be uniformly or non-uniformity spaced from one another along the longitudinal length of the one or both reciprocating saw blades. As illustrated in FIGS. 38-43, the spacing and teeth pattern of reciprocating saw blades are generally the same; however, this is not required.

The tooth depth of the teeth on reciprocating saw blades 400B, 500B and 500C is illustrated as being generally uniform; however, it can be appreciated that more than two different depths can be included on one or both of the reciprocating saw blades (e.g., 2, 3, 4, 5, 6, etc.). As illustrated in FIGS. 38-43, the tooth depth of the teeth on the reciprocating saw blade is less than the spacing of the teeth; however, this is not required Generally the ratio of the tooth depth to the spacing of the tips of the teeth is about 0.2-4:1, typically about 0.25-2:1, more typically about 0.3-1:1, still more typically about 0.3-0.99:1, and yet still more typically about 0.4-0.65:1.

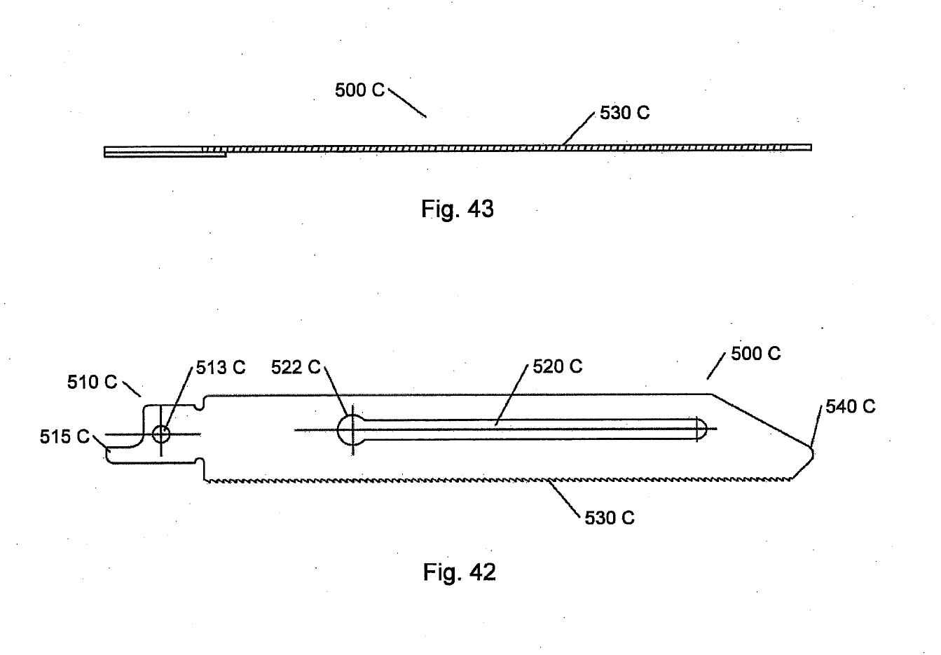

The radius of curvature between adjacently positioned teeth can be the same or different along the longitudinal length of the one or both of the reciprocating saw blades. As illustrated in FIGS. 38-43, the radius of curvature between the teeth is generally the same; however, this is not required. The teeth are each formed by two angled legs and a curved transition. As illustrated in FIGS. 38 and 42, the first leg of the teeth is illustrated as being perpendicular or near perpendicular to the longitudinal axis of the reciprocating saw blade and the second leg is illustrate at being a small angle relative to the longitudinal axis of the reciprocating saw blade than the first leg. The tip of the teeth appear to be angling toward the front end of the reciprocating saw blade.

In one non-limiting design, the angle of the first leg of the teeth to the longitudinal axis of the reciprocating saw blade is about 50-100°, typically about 70-90°, more typically about 80-90°, and still more typically about 85-89°. In another one non-limiting design, the angle of the second leg of the teeth to the longitudinal axis of the reciprocating saw blade is about 10-60°, typically about 15-50°, more typically about 25-40°, and still more typically about 30-38°. As illustrated in FIG. 40, the second leg of the teeth is illustrated as being perpendicular or near perpendicular to the longitudinal axis of the reciprocating saw blade and the first leg is illustrate at being a small angle relative to the longitudinal axis of the reciprocating saw blade than the second leg. The tip of the teeth appear to be angling away from the front end of the reciprocating saw blade. In one non-limiting design, the angle of the second leg of the teeth to the longitudinal axis of the reciprocating saw blade is about 50-100°, typically about 70-90°, more typically about 80-90°, and still more typically about 85-89°. In another one non-limiting design, the angle of the first leg of the teeth to the longitudinal axis of the reciprocating saw blade is about 10-60°, typically about 15-50°, more typically about 25-40°, and still more typically about 30-38°. As can be appreciated, the tooth shape and profile of the reciprocating saw blade illustrated in FIG. 40 can be a mirror image of the tooth shape and profile of the reciprocating saw blade illustrated in FIGS. 38 and 42; however, this is not required.

The teeth can include a sloped face; however this is not required. The angle of slope for the teeth can be the same or different. The angle slope can be on one or both sides of the teeth. The angle can be uniform or non-uniform along the length of each side of the tooth. The surface area of the sloped portion can be constant or vary along the length of each side of the tooth.

The teeth can be oriented to be parallel to the longitudinal axis of the reciprocating saw blade to be at some angle to the longitudinal axis of the reciprocating saw blade. The angle of each of the teeth can be the same or different along the longitudinal axis of the reciprocating saw blade. As illustrated in FIGS. 39, 41 and 43, the teeth are positioned at an angle to the longitudinal axis of the reciprocating saw blade. As illustrated in FIGS. 39 and 41, the teeth are angled in the same direction and can be optionally angled at the same or similar angle. As illustrated in FIGS. 39 and 43, the teeth are angled in the opposite direction. In FIGS. 39 and 41, the teeth are angled in the same direction since the tips of the teeth of the two reciprocating saw blades are angled in opposite direction. In FIGS. 39 and 43, the teeth are angled in the opposite direction since the tips of the teeth of the two reciprocating saw blades are angled in the same direction. when one or more of the teeth on the reciprocating saw blade are angled, the angle is generally about 2-40, typically about 5-25°, and more typically about 10-20°; however, other angles can be used.

The tip of the teeth on the reciprocating saw blades generally lie in the same plane as illustrated in FIGS. 38, 40, and 42; however, this is not required. The tip 440B, 540B, 540C of the reciprocating saw blades can have a curved or generally pointed shape. The slope angle on both sides of the tip can be the same or different. In one specific example, the slope angle on tip top surface for the reciprocating saw blades is about 30-60°, typically 35-55°, more typically about 40-50°; however, other angles can be used. In another specific example, the slope angle on tip bottom surface for the reciprocating saw blades is about 20-50°, typically 20-35°, more typically about 25-35°; however, other angles can be used. The top surface of the reciprocating saw blades that is located on the opposite side of the tooth tips can be parallel or non-parallel to the plane of the tooth teeth.

As illustrated in FIGS. 39, 41 and 43, the back end of the reciprocating saw blades can optionally include a thicker reinforcement section used to provide rigidity to the saw blades and/or facilitate in connecting the saw blades to the reciprocating saw.

In one non-limiting tooth configuration for one or more of the reciprocating saw blades, one or more of the teeth have a top edge that is both angled and tapered; however, this is not required.

As can be appreciated, the top edge or surface of one or more teeth can have an angled surface, a tapered surface, or both an angled and tapered surface. The angle of the angled surface and the angle of the tapered surface is non-limiting. The angled and/or tapered surface can be continuous along the length of the tooth; however, this is not required. The angle of the angled and/or tapered surface can be constant or vary along the length of the tooth. For example, the angle of the one or more tapers of one or more teeth relative to the longitudinal axis of the reciprocating saw blade is about 5°-70°, generally about 10°-60°, typically about 15°-45°, and more typically about 30°; however, it will be appreciated, that other taper angles can be used.

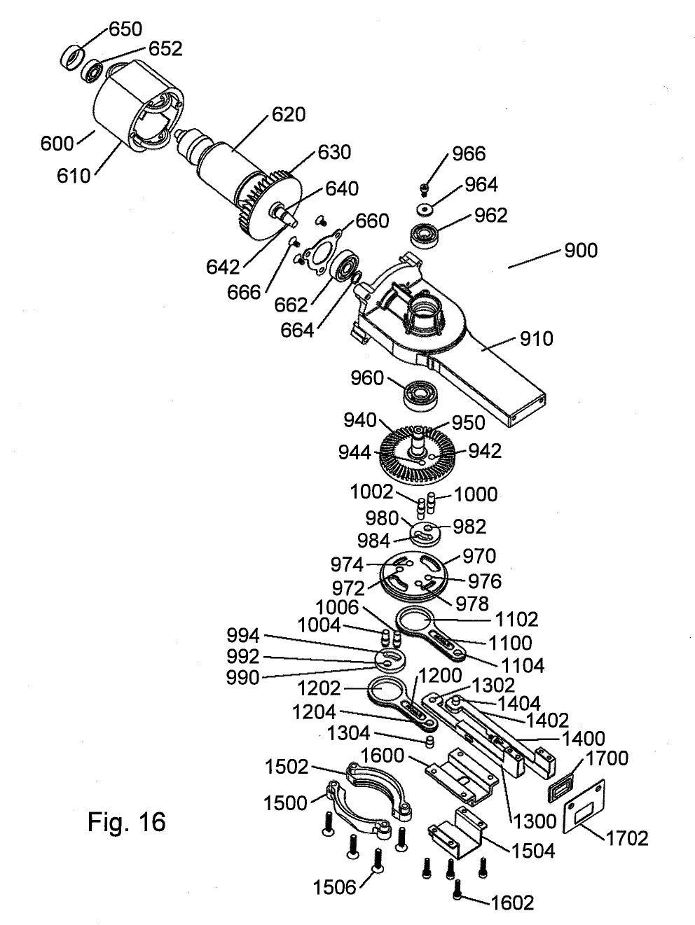

In one non-limiting configuration, the angled and/or tapered surface, when used, is selected to cause one or both blades to more toward one another when cutting through a material; however, this is not required. Such a configuration can result in the elimination of a blade connector such as a connector illustrated in FIG. 16; however, this is not required. One or more inner surface of the blades can include one or more blade separators to maintain the spacing of the blades from one another during the operation of the blade; however, this is not required. The number and/or shape of the blade separators, when used, are non-limiting.

Intermediate teeth, not shown, can be positioned between the main teeth of the reciprocating saw blades. The intermediate teeth, when used, can be tall or shorted than the main teeth.

The teeth shape, tapered surface and/or the outward angling of one or more teeth on one or both reciprocating saw blades is generally used to 1) improve the cutting of material by one or both reciprocating saw blades, 2) cause the two reciprocating saw blades to be pushed together during the cutting of material, 3) reduce the wear on one or both reciprocating saw blades when cutting material, 4) reduce the vibration and/or jerking action caused by one or both reciprocating saw blades during the cutting of material, 5) enable one or both reciprocating saw blades to cut material on both the forward and return stroke of one or both reciprocating saw blades, 6) balance the cutting action of the two reciprocating saw blades, 7) improve the accuracy of the cut in a material by the two reciprocating saw blades, 8) form smoother cuts through a material, 8) reduce the fatigue on the user during the cutting of material, and/or 9) facilitate in the removal of cut material during the cutting of the material by one or both reciprocating saw blades. As can be appreciated, the tapered surface and/or the outward angling of one or more teeth on one or both reciprocating saw blades can have other or additional functions.

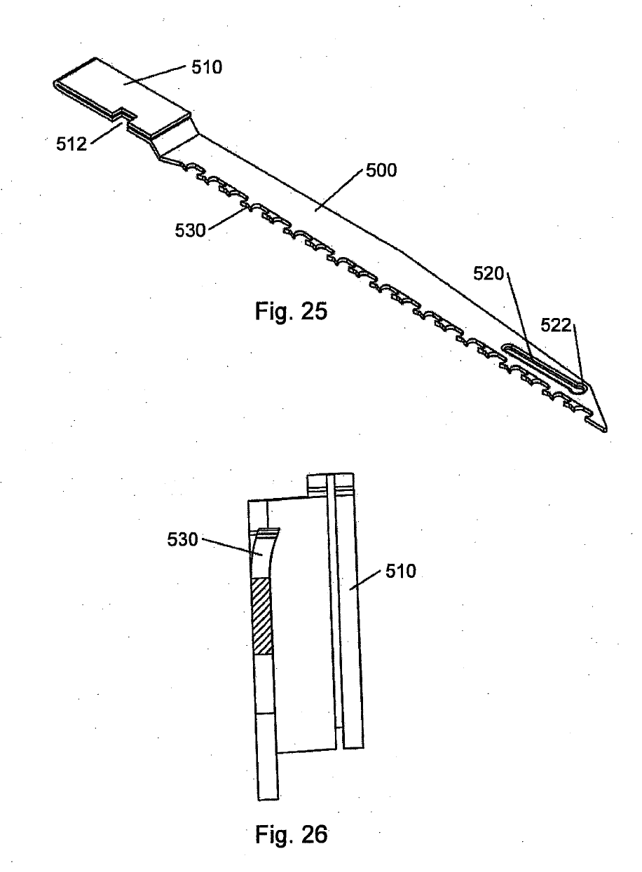

The material used to form the reciprocating saw blades is non-limiting. The front end of the reciprocating saw blades can be pointed, rounded, hook-shaped, or have some other shape. The tooth profile and/or tooth spacing can be the same along the longitudinal length of the reciprocating saw blades or vary along the longitudinal length of the reciprocating saw blades. When teeth are located on both sides of the reciprocating saw blades, the tooth configuration can be the same or different on both sides of the reciprocating saw blades. Generally, the length, thickness, height (width), shape and material of the two reciprocating saw blades is the same; however, this is not required. The height (width) of one or both reciprocating saw blades can be constant or vary along the longitudinal length of the reciprocating saw blades. In one non-limiting configuration, the height (width) of both reciprocating saw blades varies along the longitudinal length of the reciprocating saw blades. As illustrated in FIGS. 23, 25 and 28, the height (width) of the reciprocating saw blades reduces at least along a portion of the longitudinal length of the reciprocating saw blades. The reciprocating saw blades in FIGS. 23 and 25 both increase and decrease in the height (width) along the longitudinal length of the reciprocating saw blades.

The gear arrangement used to cause one or both reciprocating saw blades to reciprocate is non-limiting. The gear arrangement can be designed to cause one or both reciprocating saw blades to reciprocate in a single plane, or cause one or both reciprocating saw blades to travel an elliptical or orbital path during the reciprocation of one or both reciprocating saw blades. When two reciprocating saw blades are reciprocated by the reciprocating saw, generally both reciprocating saw blades move in the same path or plane; however, this is not required.

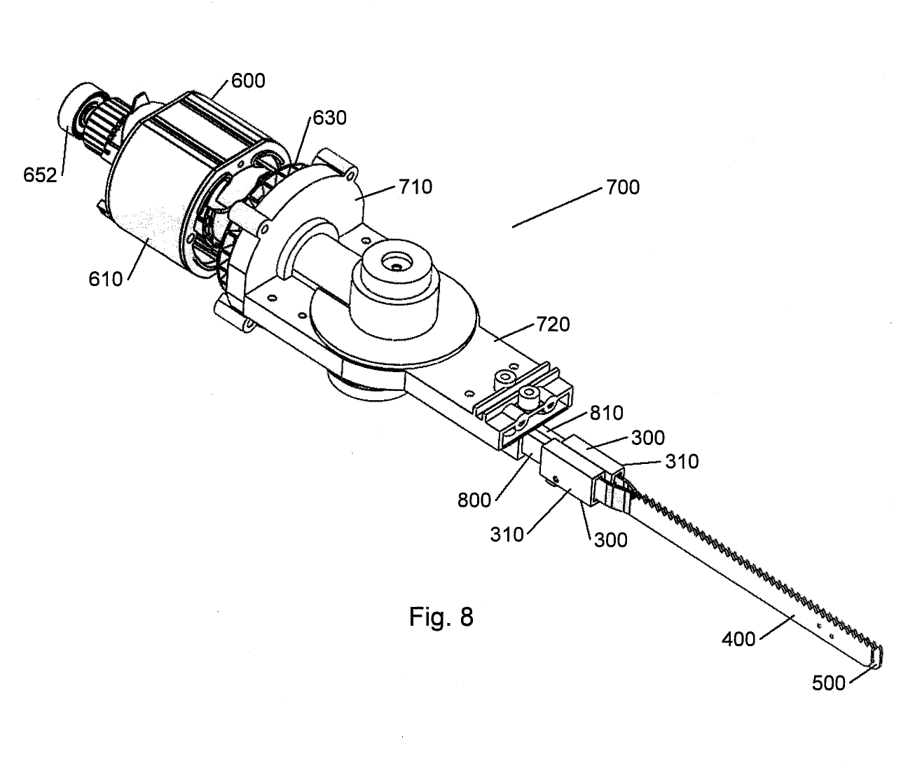

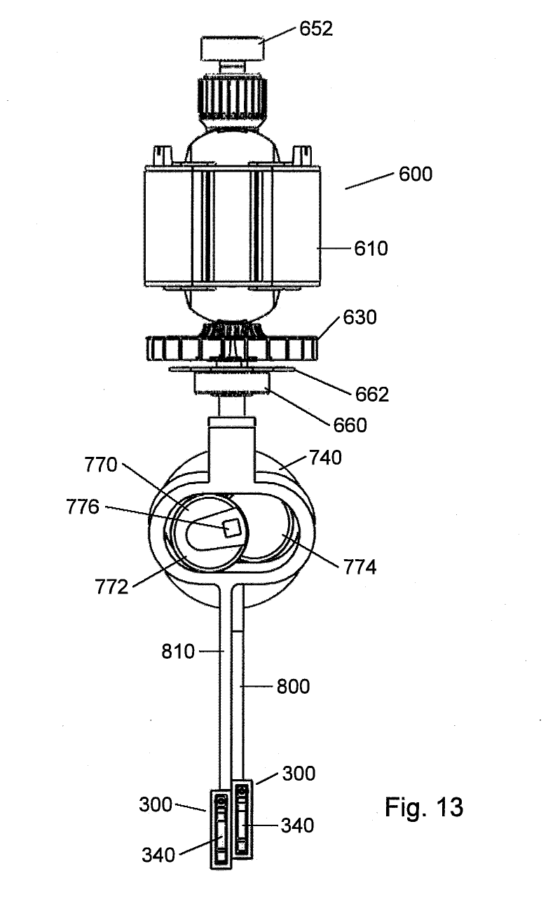

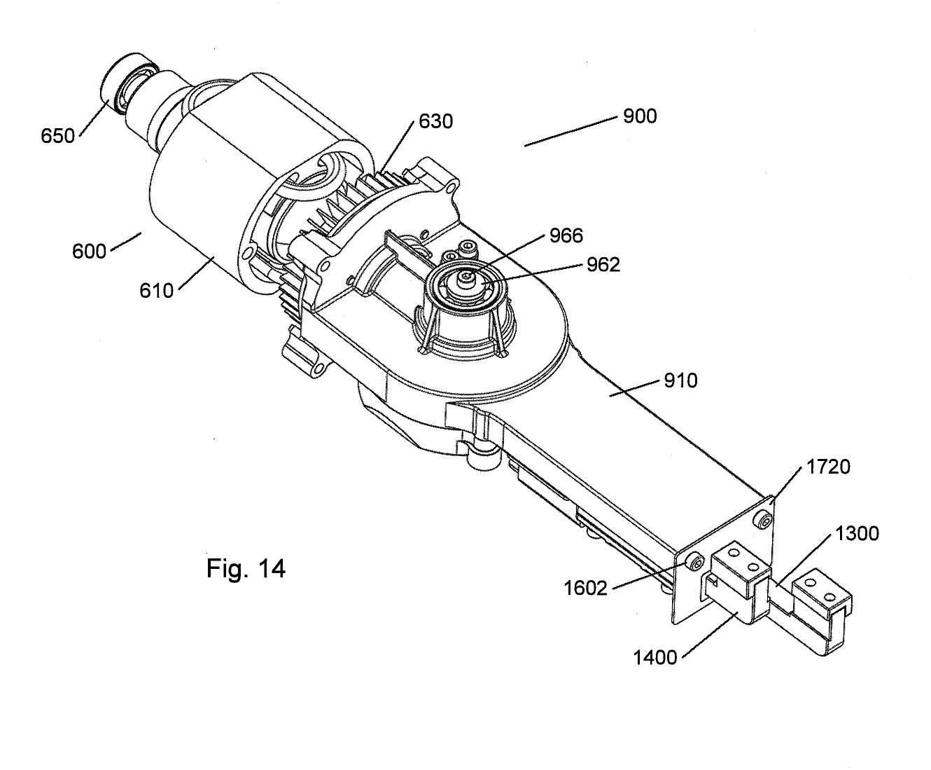

FIGS. 8-13 illustrate one non-limiting gear arrangement 700 that is for a single stroke operation of the reciprocating saw. FIGS. 14-19 illustrate one non-limiting gear arrangement 900 that is for a dual or two stroke operation of the reciprocating saw.

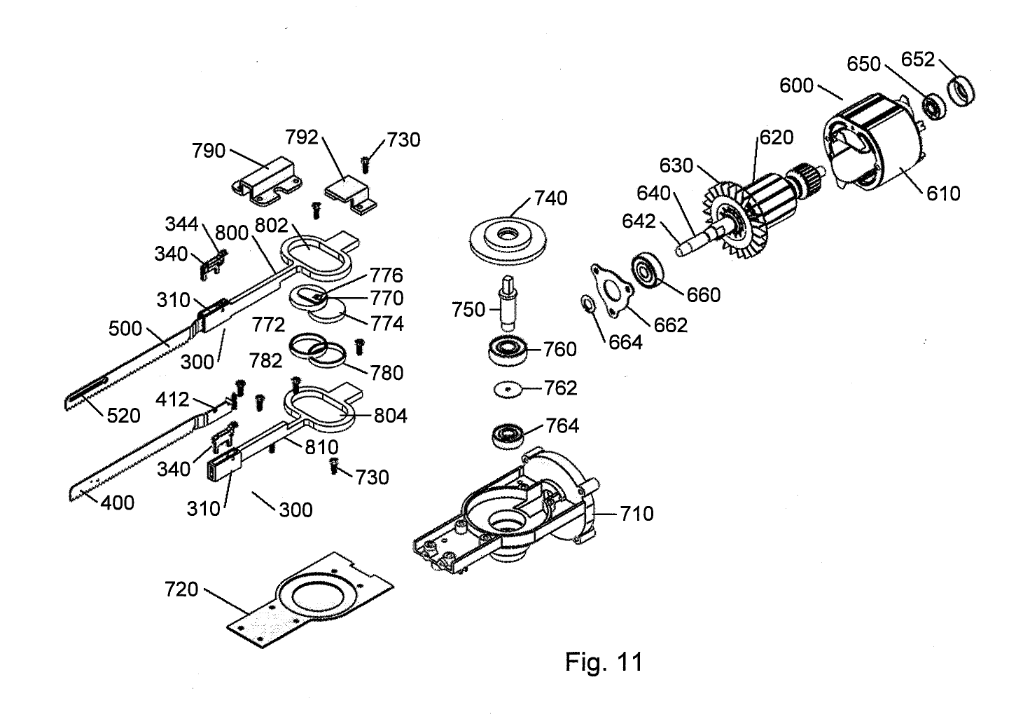

Referring now to gear arrangement 700 illustrated in FIGS. 8-13, there is illustrated a motor 600 that is used to drive the novel gearing in gear arrangement 700 to cause one or two reciprocating saw blades 400, 500 to reciprocate with the motor is operating. When two reciprocating saw blades are connected to the gear arrangement, the gear arrangement is designed to cause the two reciprocating saw blades to reciprocate in opposite directions. Many different gear arrangements can be used to cause the two reciprocating saw blades to reciprocate in opposite directions. One non-limiting gear arrangement is illustrated in FIGS. 8-13. As illustrated in FIG. 11, the motor 600 includes a housing 610 that includes brushes and a winding to cause an armature 620 to rotate. A motor cooling fan blade 630 can be optionally connected to the armature to cool the motor during operation. The front portion 640 of the armature can include a taper portion 642 that includes gear teeth, not shown. The motor is designed to cause the armature to rotate in a clockwise and/or counterclockwise direction. The motor can be a variable speed motor; however, this is not required. A bearing and cap 650, 652 can be optionally used to secure the rear portion of the armature in motor housing 610. Likewise, washers, bearings and plates 660, 662, 664 can be optionally used to secure the fan blade 630 on the armature.

The gear arrangement 700 includes a main gear housing 710 and a housing plate 720 which can be connected to the main gear housing by one or more screws 730. As can be appreciated, the gear arrangement can include less than two or more than two housing components. The shape and size of the housing components are non-limiting. The manner in which the housing components are connected together is non-limiting. The materials used to form the housing components are non-limiting. Generally, all of the housing components of the gear arrangement are located in the main body portion of the reciprocating saw; however, this is not required. The front portion 640 of the armature extends through an opening in main gear housing 710. The end of the tapered end 642 of the front portion generally includes a gear region that is designed to mesh with the teeth, not shown, on main gear 740. Main gear 740 is designed to rotate about an axis that is non-parallel to the axis of rotation of the armature. Generally, the axis of rotation of the armature is normal to the axis of rotation of the main gear; however, this is not required. The main gear is connected to a gear axle 750. Washers and bearings 760, 762, 764 can be used to facilitate in the connection to the main gear housing and/or rotational movement of the gear axle relative to the main gear housing; however, this is not required. As can be appreciated, many different arrangements can be used to enable the main gear to be rotated by the armature.

An eccentric cam 770 is designed to be connected to the main gear 740 and/or gear axle 750 and rotate with the main gear and the gear axle when the armature is caused to be rotated by motor. Eccentric cam 770 includes first and second mount surfaces 772, 774. The center of the eccentric cam 770 includes an opening 776 that is designed to receive a portion of gear axle 750. Cam rings 780, 782 can be optionally connected to first and second mount surfaces 772, 774.

Gear arrangement 700 includes an arm carrier housing system that includes a first carrier housing 790 and a second carrier housing 792. The first and second carrier housings are designed to be connected to gear housing 710, through housing plate 720. One or more screws 730 or some other or additional connection means can be used to connect the first and second carrier housings to housing plate and the gear housing (e.g., adhesive, solder bond, melt bond, weld bead, rivet, nut and bolt, snap lock arrangement, clamp arrangement, etc.). The arm carrier housing system is designed to hold together and/or guide the movement of the two connecting arms 800, 810. The two connecting arms include a top opening 802, 804 that is designed to be connected to eccentric cam 770. Top opening 802 of connecting arm 800 is designed to connect to first mount surface 772 of eccentric cam 770, and top opening 812 of connecting arm 810 is designed to connect to second mount surface 774 of eccentric cam 770.

During operation, when eccentric cam 770 is caused to rotate by the motor, the eccentric cam 770 moves in a circular path. As the eccentric cam rotates, the two connecting arms 800, 810 are caused to reciprocate in opposite directions from one another. The cam rings 780, 782, when used, can facilitate on the movement of the first and second mount surfaces 772, 774 of the eccentric cam 770 within top openings 802, 804. The arm carrier housing system causes the two connecting arms to move in an axis that is parallel or generally parallel to the longitudinal axis of the armature; however, this is not required.

The end of the two connecting arms 800, 810 includes a quick disconnect arrangement 300. As mentioned above, the quick disconnect arrangement is used to connect/disconnect reciprocating saw blades 400, 500 to/from the reciprocating saw.

Referring now to FIGS. 14-19, one non-limiting gear arrangement 900 that is for a dual stroke operation of the reciprocating saw is illustrated. A motor 600 that is used to drive the novel gearing in gear arrangement 900 to cause one or two reciprocating saw blades 400, 500 to reciprocate with the motor is operating. When two reciprocating saw blades are connected to the gear arrangement, the gear arrangement is designed to cause the two reciprocating saw blades to reciprocate in opposite directions. Many different gear arrangements can be used to cause the two reciprocating saw blades to reciprocate in opposite directions. One non-limiting gear arrangement is illustrated in FIGS. 14-19. Gear arrangement 900 is designed to cause a different stroke length of one or two reciprocating blades depending on the rotational direction of motor 600.

As illustrated in FIG. 16, the motor 600 includes a housing 610 that includes brushes and a winding to cause an armature 620 to rotate. A motor cooling fan blade 630 can be optionally connected to the armature to cool the motor during operation. The front portion 640 of the armature can include a taper portion 642 that includes gear teeth, not shown. The motor is designed to cause the armature to rotate in a clockwise and counterclockwise direction. The motor can be a variable speed motor; however, this is not required. A bearing and cap 650, 652 can be optionally used to secure the rear portion of the armature in motor housing 610. Likewise, washers, bearings and plates 660, 662, 664 can be optionally used to secure the armature to the gear arrangement 900 via screws 666 or by some other attachment means.

The gear arrangement 900 includes a main gear housing 910. As can be appreciated, the gear arrangement can include more than one housing component. The shape and size of the housing component are non-limiting. The material used to form the housing component is non-limiting. Generally, the housing component of the gear arrangement is located in the main body portion of the reciprocating saw; however, this is not required. The front portion 640 of the armature extends through an opening in main gear housing 910. The end of the tapered end 642 of the front portion generally includes a gear region that is designed to mesh with the teeth, not shown, on main gear 940. Main gear 940 is designed to rotate about an axis that is non-parallel to the axis of rotation of the armature. Generally, the axis of rotation of the armature is normal to the axis of rotation of the main gear; however, this is not required. The main gear is connected to a gear axle 950. Washers, bearings and screws 960, 962, 964, 966 can be used to facilitate in the connection to the main gear housing and/or rotational movement of the gear axle relative to the main gear housing; however, this is not required. As can be appreciated, many different arrangements can be used to enable the main gear to be rotated by the armature.

An eccentric gear 970 is designed to be connected to the main gear 940 and rotate with the main gear when the armature is caused to be rotated by motor. The eccentric gear 970 includes two sets of pin openings 972, 974 and 976, 978. The pin openings are used secure first and second eccentric cams 980, 990 to the eccentric gear. Pins 1000, 1002 are used to secure eccentric cam 980 to the top surface of the eccentric gear and pins 1004, 1006 are used to secure eccentric cam 990 to the bottom surface of the eccentric gear. Eccentric cam 980 includes an opening 982 and a slot 984. The first ends of pins 1000, 1002 are designed to connect to openings 976, 978 in eccentric gear 970. The second end of pins 1000, 1002 are designed to connect to openings 942, 944 of main gear 940. The body of pins 1000, 1002 is designed to pass through opening 982 and a slot 984 of eccentric cam 980 such that eccentric cam 980 is positioned between the bottom surface of main gear 940 and the top surface of eccentric gear 970. Eccentric cam 980 is designed to be movable when positioned between main gear 940 and eccentric gear 970 as will be discussed in more detail below. Eccentric cam 990 includes an opening 992 and a slot 994. The first ends of pins 1004, 1006 are designed to be positioned in opening 992 and slot 994 in eccentric cam 990. The second end of pins 1004, 1006 are designed to connect to openings 972, 974 of eccentric gear 970. Eccentric cam 990 is designed to be movable relative to eccentric gear 970 as will be discussed in more detail below.

The outer perimeter of eccentric cam 980 is designed to be positioned in opening 1102 of connecting arm 1100 and the outer perimeter of eccentric cam 990 is designed to be positioned in opening 1202 of connecting arm 1200. The end of connecting arm 1100 includes a connection opening 1104 that is used to connect the end of connecting arm 1100 to rear end 1402 of blade carrier arm 1400. A pin 1404 can be used to secure connecting arm 1100 to blade carrier arm 1400. Likewise, the end of connecting arm 1200 includes a connection opening 1304 that is used to connect the end of connecting arm 1200 to rear end 1302 of blade carrier arm 1300. A pin 1304 can be used to secure connecting arm 1200 to blade carrier arm 1300.

One or more gear retainers and connectors 1500, 1502, and 1504 can be used to maintain the gears and cams of the gear arrangement is place relative to the gear housing by screws 1506 or some other or additional connecting means. The configuration and type of gear retainers and connectors used is non-limiting. Gear arrangement 900 can include an arm carrier housing 1600 that is designed to be connected to main gear housing 910 by one or more screws 1602 or some other or additional connection means (e.g., adhesive, solder bond, melt bond, weld bead, rivet, nut and bolt, snap lock arrangement, clamp arrangement, etc.). The arm carrier housing is designed to hold together and/or guide the movement of the two blade carrier arms 1300, 1400 during the reciprocation of the two blade carrier arms, as well as to inhibit or prevent dirt, debris, cut material, etc., from entering the main gear housing. Guide plates 1700, 1702 can also be used to hold together and/or guide the movement of the two blade carrier arms 1300, 1400 during the reciprocation of the two blade carrier arms. The guide plates can be designed to be connected to the front end of the main gear housing 910 by one or more screws 1602 or some other or additional connection means (e.g., adhesive, solder bond, melt bond, weld bead, rivet, nut and bolt, snap lock arrangement, clamp arrangement, etc.); however, this is not required.

The front ends of the two blade carrier arms 1300, 1400 can be connected to a quick disconnect arrangement 300 or some other connection arrangement that is used to secure the reciprocating saw blades 400, 500 to the two blade carrier arms.

During operation, when main gear 940 and eccentric gear 970 are caused to rotate by the motor, the main gear and eccentric gear move in a circular path. As the eccentric gear rotates, the two eccentric cams that are connected off-center to the eccentric gear are also cause to rotate. As the two eccentric cams rotate with the eccentric gear, the two connecting arms 110, 1200 are caused to reciprocate in opposite directions from one another. The reciprocation of the two connecting arms causes the two blade carrier arms 1300, 1400 to also reciprocate in opposite directions from one another. The arm carrier housing system causes the two blade carrier arms to move in an axis that is parallel or generally parallel to the longitudinal axis of the armature; however, this is not required. The end of the two blade carrier arms can include a quick disconnect arrangement 300; however, this is not required. As mentioned above, the quick disconnect arrangement is used to connect/disconnect reciprocating saw blades 400, 500 to/from the reciprocating saw. As mentioned above, a quick disconnect arrangement is not required for use on the reciprocating saw. When a quick disconnect arrangement is not used, the one or more reciprocating saw blades can be connected/disconnected from the main body of the reciprocating saw by use of washers, hex screws, etc. which require tools (e.g., screw driver, pliers, wrench, etc.) to remove and/or attach one or both reciprocating saw blades to the main body of the reciprocating saw.

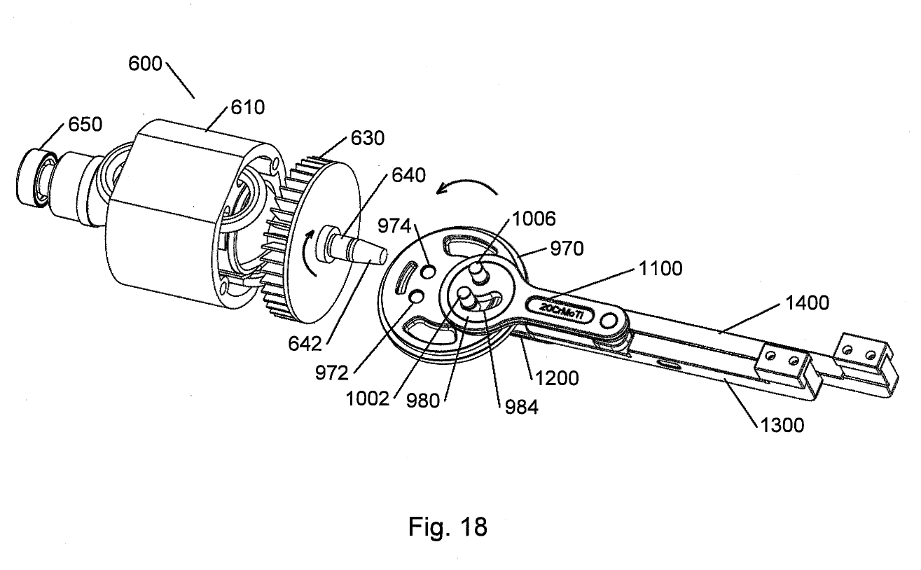

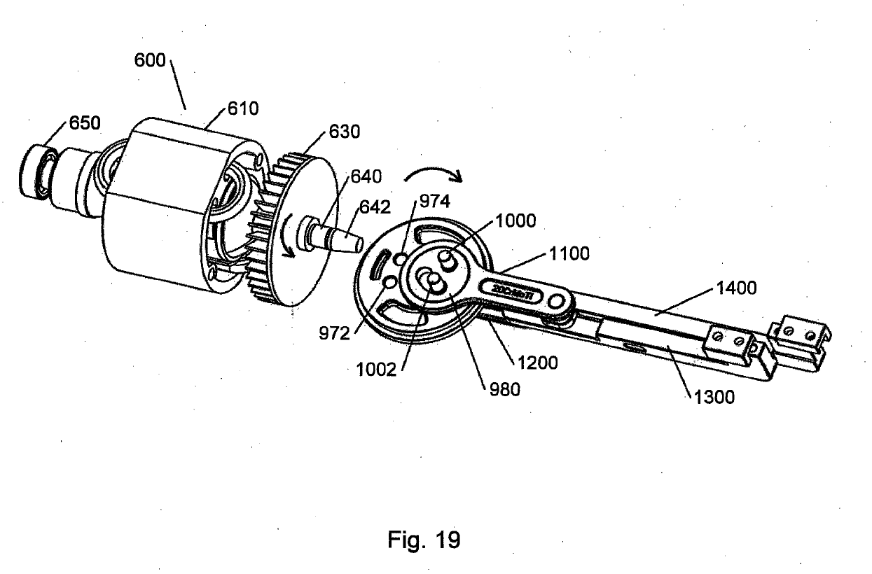

The gear arrangement is designed to change the stroke length depending of the rotation of the armature. FIG. 18 illustrates the long stroke length produce by the gear arrangement and FIG. 19 illustrates the short stroke length produce by the gear arrangement. When motor 600 causes the armature to rotate in the clockwise direction as indicated by the arrow in FIG. 18, the eccentric gear 970 is cause to rotate in the counter-clockwise direction as indicated by the arrow. The rotation of the eccentric gear 970 causes the eccentric cams 980, 990 to pivot on one pin while the other pin moves with the slot 984, 994. When motor 600 causes the armature to rotate in the counter-clockwise direction as indicated by the arrow in FIG. 19, the eccentric gear 970 is cause to rotate in the clockwise direction as indicated by the arrow. The rotation of the eccentric gear 970 causes the eccentric cams 980, 990 to pivot on one pin while the other pin moves with the slot 984, 994. The movement of the eccentric cam 980 results in the change in the stroke length. As illustrated in FIG. 18, eccentric cam 980 is rotated to its maximum clockwise position when the eccentric gear 970 rotates in the counter-clockwise direction. Although not shown, eccentric cam 990 is rotated to its maximum counter-clockwise position when the eccentric gear 970 rotates in the counter-clockwise direction. As illustrated in FIG. 19, eccentric cam 980 is rotated to its minimum counter-clockwise position when the eccentric gear 970 rotates in the clockwise direction. Although not shown, eccentric cam 990 is rotated to its minimum clockwise position when the eccentric gear 970 rotates in the clockwise direction. As can be appreciated, gear arrangement 900 can be modified so not only one eccentric cam rotates relative to the eccentric gear while the other remains in position. As can be appreciated, other gear arrangements can be used to create a multi-stroke gear arrangement for a reciprocating saw.

The dual stroke option is a significant advantage over single stroke reciprocating saws. A single stroke reciprocating saw generally has a fixed stroke depth anywhere between 0.75-1.25 inches. The dual stroke reciprocating saw of the present invention can produce a first stroke length of about 0.6-0.8 inches (e.g., 0.75 inches, etc.) and a second stroke length of about 1-1.5 inches (e.g., 1.25 inches, etc.). As can be appreciated, other stroke ranges can be used for the first and/or second stroke length.

As can be appreciated, gear arrangement 900 can be converted into a single stroke arrangement by merely preventing the eccentric cams 980, 990 from moving relative to eccentric gear 970. This arrangement can be simple accomplished by eliminating slots 984, 994; or eliminating the eccentric cams and having the connecting arms 1100, 1200 connected to the eccentric gear. As can be appreciated, other arrangements can be used to create a single strike or multi-stroke gear arrangement for a reciprocating saw.

It can also be appreciated that gear arrangement 900 can be converted to a single blade saw with adjustable stroke by merely eliminating one set of eccentric cam 990, connecting arm 1200, blade carrier arm 1300, and miscellaneous pins 1004, 1006, and 1304.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

1-25. (canceled)

26. A reciprocating saw for cutting material, said reciprocating saw comprising a body and a drive system and a gear arrangement that is at least partially positioned in said body, said drive system and a gear arrangement designed to cause first and second reciprocating saw blades to partially or fully reciprocate in opposite directions, said gear arrangement connected or interconnected to first and second blade carrying arms, said first reciprocating saw blade connected to said first blade carrying arm, said second reciprocating saw blade connected to said second blade carrying arm, said gear arrangement causing said first and second blade carrying arms to move when said drive system is activated to thereby cause said first and second reciprocating saw blades to partially or fully reciprocate in opposite directions relative to one another, said first reciprocating saw blade including a tooth configuration that causes said first reciprocating saw blade to resist separating from said second reciprocating saw blade as said first and second reciprocating saw blades reciprocate and cut through material.

27. The reciprocating saw as defined in claim 26, wherein said second reciprocating saw blade includes a tooth configuration that causes said second reciprocating saw blade to resist separating from said first reciprocating saw blade as said first and second reciprocating saw blades reciprocate and cut through material.

28. The reciprocating saw as defined in claim 26, wherein said first reciprocating saw blade includes a tooth configuration that causes said first reciprocating saw blade to move toward said second reciprocating saw blade as said first and second reciprocating saw blades reciprocate and cut through material.

29. The reciprocating saw as defined in claim 26, wherein said second reciprocating saw blade includes a tooth configuration that causes said second reciprocating saw blade to move toward said first reciprocating saw blade as said first and second reciprocating saw blades reciprocate and cut through material.

30. The reciprocating saw as defined in claim 26, wherein a plurality of teeth of said first reciprocating saw blade is oriented at an angle that is non-parallel to a longitudinal axis of said first reciprocating saw blade.

31. The reciprocating saw as defined in claim 26, wherein a plurality of teeth of said second reciprocating saw blade is oriented at an angle that is non-parallel to a longitudinal axis of said second reciprocating saw blade.

32. The reciprocating saw as defined in claim 26, wherein a plurality of teeth of said second reciprocating saw blade is oriented at an angle that is non-parallel to a longitudinal axis of said second reciprocating saw blade.

33. The reciprocating saw as defined in claim 26, wherein a plurality of tips of said teeth on said first and second reciprocating saw blades angle toward a front end of said first and second reciprocating saw blades, and a plurality of teeth of said first reciprocating saw blade oriented at an angle that is non-parallel to a longitudinal axis of said first reciprocating saw blade and which angle is opposite an angle of a plurality of said teeth on said second reciprocating saw blade.

34. The reciprocating saw as defined in claim 26, wherein a plurality of tips of said teeth on said first reciprocating saw blade angles toward a front end of said first reciprocating saw blade and a plurality of tips of said teeth on said second reciprocating saw blade angles toward a rear end of said second reciprocating saw blade, and a plurality of teeth of said first and second reciprocating saw blades oriented at an angle that is non-parallel to a longitudinal axis of said first and second reciprocating saw blades and which angle is the same.

35. A pair of saw blades for use on a reciprocating saw, a first reciprocating saw blade including a tooth configuration that causes said first reciprocating saw blade to resist separating from a second reciprocating saw blade as said first and second reciprocating saw blades reciprocate and cut through material, said second reciprocating saw blade includes a tooth configuration that causes said second reciprocating saw blade to resist separating from said first reciprocating saw blade as said first and second reciprocating saw blades reciprocate and cut through material.

36. The pair of saw blades as defined in claim 35, wherein said first reciprocating saw blade includes a tooth configuration that causes said first reciprocating saw blade to move toward said second reciprocating saw blade as said first and second reciprocating saw blades reciprocate and cut through material.

37. The pair of saw blades as defined in claim 35, wherein said second reciprocating saw blade includes a tooth configuration that causes said second reciprocating saw blade to move toward said first reciprocating saw blade as said first and second reciprocating saw blades reciprocate and cut through material.

38. The pair of saw blades as defined in claim 35, wherein a plurality of teeth of said first reciprocating saw blade is oriented at an angle that is non-parallel to a longitudinal axis of said first reciprocating saw blade.

39. The pair of saw blades as defined in claim 35, wherein a plurality of teeth of said second reciprocating saw blade is oriented at an angle that is non-parallel to a longitudinal axis of said second reciprocating saw blade.

40. The pair of saw blades as defined in claim 35, wherein a plurality of tips of said teeth on said first and second reciprocating saw blades angle toward a front end of said first and second reciprocating saw blades, and a plurality of teeth of said first reciprocating saw blade oriented at an angle that is non-parallel to a longitudinal axis of said first reciprocating saw blade and which angle is opposite an angle of a plurality of said teeth on said second reciprocating saw blade.

41. The pair of saw blades as defined in claim 35, wherein a plurality of tips of said teeth on said first reciprocating saw blade angles toward a front end of said first reciprocating saw blade and a plurality of tips of said teeth on said second reciprocating saw blade angles toward a rear end of said second reciprocating saw blade, and a plurality of teeth of said first and second reciprocating saw blades oriented at an angle that is non-parallel to a longitudinal axis of said first and second reciprocating saw blades and which angle is the same.
